(19) United States
(12) Patent Application Publication
(10) Pub. No.: US 2008/0131655 A1
(43) Pub. Date: Jun. 5, 2008

(54) Double Layer Carbon Nanotube-Based Structures and Methods for Removing Heat from Solid-State Devices

(76) Inventors: Barbara Wacker, Saratoga, CA (US); Ephraim Suhir, Los Altos, CA (US); Subrata Dey, Fremont, CA (US); Peter Schwartz, Livermore, CA (US); Rahim Kavari, Campbell, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/749,128

(22) Filed: May 15, 2007

Related U.S. Application Data
(63) Continuation-in-part of application No. 11/498,408, filed on Aug. 2, 2006.
Application No. 11/498,408 is a continuation-in-part of application No. 11/386,254, filed on Mar. 21, 2006.
Application No. 11/386,254 is a continuation-in-part of application No. 11/618,441, filed on Dec. 29, 2006.
(60) Provisional application No. 60/800,935, filed on May 16, 2006.
(60) Provisional application No. 60/874,579, filed on Dec. 12, 2006.
(60) Provisional application No. 60/908,966, filed on Mar. 29, 2007.

(51) Int. Cl. B32B 7/00

(52) U.S. Cl. 428/119

(57) ABSTRACT

Carbon nanotube-based structures and methods for removing heat from solid-state devices are disclosed. In one embodiment, a copper substrate has thermal interface materials on top of front and back surfaces of the copper substrate. Each thermal interface material (TIM) comprises a layer of carbon nanotubes and a filler material located between the carbon nanotubes. The summation of the thermal resistance of the copper substrate, the bulk thermal resistance of each TIM, the contact resistance between each TIM and the copper substrate, the contact resistance between one TIM and a solid-state device, and the contact resistance between the other TIM and a heat conducting surface has a value of 0.06 cm²K/W or less.

### RELATED APPLICATIONS

This application claims the benefit of: (A) U.S. Provisional Application No. 60/800,935, filed May 16, 2006, entitled “Small-size coupons and bonded assemblies for CNT-based thermal management of IC devices”; (B) U.S. Provisional Application No. 60/874,579, filed Dec. 12, 2006, entitled “Carbon nanotube-based structures and methods for removing heat from solid-state devices”; and (C) U.S. Provisional Application No. 60/908,966, filed Mar. 29, 2007, entitled “Double layer carbon nanotube-based structures and methods for removing heat from solid-state devices”. All of these applications are incorporated by reference herein in their entirety.

This application is a continuation-in-part of: (A) U.S. patent application Ser. No. 11/498,408, filed Aug. 2, 2006, which is a continuation of U.S. Pat. No. 7,109,581, filed Aug. 24, 2004, which in turn claims the benefit of U.S. Provisional Application No. 60/497,849 filed Aug. 25, 2003; (B) U.S. patent application Ser. No. 11/386,254, filed Mar. 21, 2006, entitled “Apparatus for attaching a cooling structure to an integrated circuit” which in turn claims the benefit of U.S. Provisional Application No. 60/663,225, filed Mar. 21, 2005; and (C) U.S. patent application Ser. No. 11/618,441, filed Dec. 29, 2006, entitled “Method and apparatus for the evaluation and improvement of mechanical and thermal properties of CNT/CNF arrays” which in turn claims the benefit of U.S. Provisional Application No. 60/862,664, filed Oct. 24, 2006. All of these applications are incorporated by reference herein in their entirety.

### TECHNICAL FIELD

The disclosed embodiments relate generally to structures and methods for removing heat from integrated circuits and other solid-state devices. More particularly, the disclosed embodiments relate to structures and methods that use carbon nanotubes to remove heat from integrated circuits and other solid-state devices.

### BACKGROUND

As the speed and density of modern integrated circuits (ICs) increase, the power generated by these chips also increases. The ability to dissipate the heat being generated by IC dies is becoming a serious limitation to advances in IC performance. Similar heat dissipation problems arise in other solid-state devices, such as light emitting diodes (LEDs), lasers, power transistors, RF devices, and solar cells.

Considerable effort has been put into developing materials and structures for use as thermal interface materials, heat spreaders, heat sinks, and other packaging components for ICs and solid-state devices, with limited success.

Thus, there remains a need to develop new structures and methods for removing heat from ICs and other solid-state devices that are compatible with current semiconductor packaging technology, provide low thermal resistances, and are low cost.

### SUMMARY

The present invention addresses the problems described above by providing carbon nanotube-based structures and methods for removing heat from IC dies and other solid-state devices.

One aspect of the invention involves an article of manufacture that includes: a copper substrate with a front surface, a back surface, and a copper substrate thermal resistance; a first catalyst on top of the front surface of the copper substrate; and a first thermal interface material on top of the front surface of the copper substrate. The first thermal interface material comprises: a first layer of carbon nanotubes that contacts the first catalyst, and a first filler material located between the carbon nanotubes in the first layer of carbon nanotubes. The carbon nanotubes in the first layer of carbon nanotubes are oriented substantially perpendicular to the front surface of the copper substrate. The first thermal interface material has: a first bulk thermal resistance, a contact resistance between the first thermal interface material and the copper substrate, and a contact resistance between the first thermal interface material and a solid-state device. The article of manufacture also includes: a second catalyst on top of the back surface of the copper substrate; and a second thermal interface material on top of the back surface of the copper substrate. The second thermal interface material comprises: a second layer of carbon nanotubes that contacts the second catalyst, and a second filler material located between the carbon nanotubes in the second layer of carbon nanotubes. The carbon nanotubes in the second layer of carbon nanotubes are oriented substantially perpendicular to the back surface of the copper substrate. The second thermal interface material has: a second bulk thermal resistance, a contact resistance between the second thermal interface material and the copper substrate, and a contact resistance between the second thermal interface material and a heat conducting surface. The summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.06 cm²K/W or less.

Another aspect of the invention involves a method that includes: forming a first catalyst on top of a front surface of a copper substrate, wherein the copper substrate has a copper substrate thermal resistance; forming a second catalyst on top of a back surface of a copper substrate; growing a first layer containing carbon nanotubes on the first catalyst; growing a second layer containing carbon nanotubes on the second catalyst; placing a first filler material between carbon nanotubes in the first layer containing carbon nanotubes; and placing a second filler material between carbon nanotubes in the second layer containing carbon nanotubes. A first thermal interface material comprises the first layer containing carbon nanotubes and the first filler material. A second thermal interface material comprises the second layer containing carbon nanotubes and the second filler material. The first thermal interface material has: a first bulk thermal resistance, a contact resistance between the first thermal interface material and the copper substrate, and a contact resistance between the first thermal interface material and a solid-state device. The second thermal interface material has: a second bulk thermal resistance, a contact resistance between the second thermal interface material and the copper substrate, and a contact resistance between the second thermal interface material and a heat conducting surface. The summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, the contact resistance between the second thermal interface material and the heat conducting surface has a value of 0.06 cm²K/W or less.

Another aspect of the invention involves a method that includes: generating heat in a solid-state device; conducting at least some of the heat away from the solid-state device via a first thermal interface material in contact with the solid-state device; conducting at least some of the heat away via a copper substrate with a front surface in contact with the first thermal interface material; conducting at least some of the heat away via second thermal interface material in contact with a back surface of the copper substrate; and conducting at least some of the heat away via a heat conducting surface in contact with the second thermal interface material. The copper substrate has a copper substrate thermal resistance. The first thermal interface material comprises: a first layer of carbon nanotubes that are oriented substantially perpendicular to the front surface of the copper substrate, and a first filler material located between carbon nanotubes in the first layer of carbon nanotubes. The first thermal interface material has: a first bulk thermal resistance, a contact resistance between the first thermal interface material and the copper substrate, and a contact resistance between the first thermal interface material and the solid-state device. The second thermal interface material comprises: a second layer of carbon nanotubes that are oriented substantially perpendicular to the back surface of the copper substrate, and a second filler material located between carbon nanotubes in the second layer of carbon nanotubes. The second thermal interface material has: a second bulk thermal resistance, a contact resistance between the second thermal interface material and the copper substrate, and a contact resistance between the second thermal interface material and the heat conducting surface. The summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.06 cm²K/W or less.

Another aspect of the invention involves an article of manufacture that includes: a heat spreader; a copper substrate with a front surface, a back surface, and a copper substrate thermal resistance; and a first thermal interface material attached to the front surface of the copper substrate comprising a first layer of carbon nanotubes and a first filler material located between carbon nanotubes in the first layer of carbon nanotubes. The carbon nanotubes in the first layer of carbon nanotubes are oriented substantially perpendicular to the front surface of the copper substrate. The first thermal interface material has: a first bulk thermal resistance, a contact resistance between the first thermal interface material and the front surface of the copper substrate, and a contact resistance between the first thermal interface material and a solid-state device. The article of manufacture also includes a second thermal interface material attached to the back surface of the copper substrate comprising a second layer of carbon nanotubes and a second filler material located between carbon nanotubes in the second layer of carbon nanotubes. The carbon nanotubes in the second layer of carbon nanotubes are oriented substantially perpendicular to the back surface of the copper substrate. The second thermal interface material has: a second bulk thermal resistance, a contact resistance between the second thermal interface material and the back surface of the copper substrate, and a contact resistance between the second thermal interface material and a heat conducting surface of the heat spreader. The summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.06 cm²K/W or less.

Another aspect of the invention involves a method that includes: growing a first layer containing carbon nanotubes on top of a front surface of a copper substrate, wherein the first layer of carbon nanotubes are oriented substantially perpendicular to the front surface of the copper substrate; growing a second layer containing carbon nanotubes on top of a back surface of a copper substrate, wherein the second layer of carbon nanotubes are oriented substantially perpendicular to the back surface of the copper substrate; placing a first filler material between carbon nanotubes in the first layer containing carbon nanotubes; placing a second filler material between carbon nanotubes in the second layer containing carbon nanotubes; and contacting a heat conducting surface with a second thermal interface material. The copper substrate has a copper substrate thermal resistance. A first thermal interface material comprises the first layer containing carbon nanotubes and the first filler material. The first thermal interface material has: a first bulk thermal resistance, a contact resistance between the first thermal interface material and the copper substrate, and a contact resistance between the first thermal interface material and a solid-state device. The second thermal interface material comprises the second layer containing carbon nanotubes and the second filler material. The second thermal interface material has: a second bulk thermal resistance, a contact resistance between the second thermal interface material and the copper substrate, and a contact resistance between the second thermal interface material and a heat conducting surface. The summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.06 cm²K/W or less.

Another aspect of the invention involves a method that includes placing a first filler material between carbon nanotubes in a first layer containing carbon nanotubes to form a first thermal interface material. The first thermal interface material has: a first bulk thermal resistance, a contact resistance between the first thermal interface material and a copper substrate, and a contact resistance between the first thermal interface material and a solid-state device. The method also includes placing a second filler material between carbon nanotubes in a second layer containing carbon nanotubes to form a second thermal interface material. The second thermal interface material has: a second bulk thermal resistance, a contact resistance between the second thermal interface material and the copper substrate, and a contact resistance between the second thermal interface material and a heat conducting surface. The copper substrate has a copper substrate thermal resistance. The summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.06 cm²K/W or less.

Another aspect of the invention involves an article of manufacture that includes: a solid-state device; a heat spreader; a copper substrate with a front surface, a back surface, and a copper substrate thermal resistance; and a first thermal interface material attached to the front surface of the copper substrate and contacting the solid-state device. The first thermal interface material comprises a first layer of carbon nanotubes and a first filler material located between carbon nanotubes in the first layer of carbon nanotubes. The carbon nanotubes in the first layer of carbon nanotubes are oriented substantially perpendicular to the front surface of the copper substrate. The first thermal interface material has: a first bulk thermal resistance, a contact resistance between the first thermal interface material and the copper substrate, and a contact resistance between the first thermal interface material and the solid-state device. The article of manufacture also includes a second thermal interface material attached to the back surface of the copper substrate comprising a second layer of carbon nanotubes and a second filler material located between carbon nanotubes in the second layer of carbon nanotubes. The carbon nanotubes in the second layer of carbon nanotubes are oriented substantially perpendicular to the back surface of the copper substrate. The second thermal interface material has: a second bulk thermal resistance, a contact resistance between the second thermal interface material and the back surface of the copper substrate, and a contact resistance between the second thermal interface material and a heat conducting surface of the heat spreader. The summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.06 cm²K/W or less.

Another aspect of the invention involves a method that includes contacting a solid-state device with a first thermal interface material. The first thermal interface material is attached to a front surface of a copper substrate. A back surface of the copper substrate is attached to a second thermal interface material. The second thermal interface material is attached to a heat conducting surface. The first thermal interface material comprises: a first layer of carbon nanotubes that are oriented substantially perpendicular to the front surface of the copper substrate, and a first filler material located between the carbon nanotubes in the first layer of carbon nanotubes. The first thermal interface material has: a first bulk thermal resistance, a contact resistance between the first thermal interface material and the copper substrate, and a contact resistance between the first thermal interface material and the solid-state device. The second thermal interface material comprises: a second layer of carbon nanotubes that are oriented substantially perpendicular to the back surface of the copper substrate, and a second filler material located between the carbon nanotubes in the second layer of carbon nanotubes. The second thermal interface material has: a second bulk thermal resistance, a contact resistance between the second thermal interface material and the copper substrate, and a contact resistance between the second thermal interface material and the heat conducting surface. The summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.06 cm²K/W or less.

One aspect of the invention involves an article of manufacture that includes: a copper substrate with a front surface, a back surface, and a copper substrate thermal resistance; a first catalyst on top of the front surface of the copper substrate; and a first thermal interface material on top of the front surface of the copper substrate. The first thermal interface material comprises: a first layer of carbon nanotubes that contacts the first catalyst, and a first filler material located between the carbon nanotubes in the first layer of carbon nanotubes. The carbon nanotubes in the first layer of carbon nanotubes are oriented substantially perpendicular to the front surface of the copper substrate. The first thermal interface material has: a first bulk thermal resistance, a contact resistance between the first thermal interface material and the copper substrate, and a contact resistance between the first thermal interface material and a first heat conducting surface. The article of manufacture also includes: a second catalyst on top of the back surface of the copper substrate; and a second thermal interface material on top of the back surface of the copper substrate. The second thermal interface material comprises: a second layer of carbon nanotubes that contacts the second catalyst, and a second filler material located between the carbon nanotubes in the second layer of carbon nanotubes. The carbon nanotubes in the second layer of carbon nanotubes are oriented substantially perpendicular to the back surface of the copper substrate. The second thermal interface material has: a second bulk thermal resistance, a contact resistance between the second thermal interface material and the copper substrate, and a contact resistance between the second thermal interface material and a second heat conducting surface. The summation of the first bulk thermal resistance, the contact resistance between the first thermal interface material and the copper substrate, the contact resistance between the first thermal interface material and the first heat conducting surface, the copper substrate thermal resistance, the second bulk thermal resistance, the contact resistance between the second thermal interface material and the copper substrate, and the contact resistance between the second thermal interface material and the second heat conducting surface has a value of 0.06 cm²K/W or less.

Another aspect of the invention involves a method that includes: forming a first catalyst on top of a front surface of a copper substrate, wherein the copper substrate has a copper substrate thermal resistance; forming a second catalyst on top of a back surface of a copper substrate; growing a first layer containing carbon nanotubes on the first catalyst; growing a second layer containing carbon nanotubes on the second catalyst; placing a first filler material between carbon nanotubes in the first layer containing carbon nanotubes; and placing a second filler material between carbon nanotubes in the second layer containing carbon nanotubes. A first thermal interface material comprises the first layer containing carbon nanotubes and the first filler material. A second thermal interface material comprises the second layer containing carbon nanotubes and the second filler material. The first thermal interface material has: a first bulk thermal resistance, a contact resistance between the first thermal interface material and the copper substrate, and a contact resistance between the first thermal interface material and a first heat conducting surface. The second thermal interface material has: a second bulk thermal resistance, a contact resistance between the second thermal interface material and the copper substrate, and a contact resistance between the second thermal interface material and a second heat conducting surface. The summation of the first bulk thermal resistance, the contact resistance between the first thermal interface material and the copper substrate, the contact resistance between the first thermal interface material and the first heat conducting surface, the copper substrate thermal resistance, the second bulk thermal resistance, the contact resistance between the second thermal interface material and the copper substrate, and the contact resistance between the second thermal interface material and the second heat conducting surface has a value of 0.06 cm²K/W or less.

Another aspect of the invention involves a method that includes: conducting heat in an article with a first heat conducting surface; conducting at least some of the heat away from the article via a first thermal interface material in contact with the first heat conducting surface; conducting at least some of the heat away via a copper substrate with a front surface in contact with the first thermal interface material; conducting at least some of the heat away via second thermal interface material in contact with a back surface of the copper substrate; and conducting at least some of the heat away via a second heat conducting surface in contact with the second thermal interface material. The copper substrate has a copper substrate thermal resistance. The first thermal interface material comprises: a first layer of carbon nanotubes that are oriented substantially perpendicular to the front surface of the copper substrate, and a first filler material located between carbon nanotubes in the first layer of carbon nanotubes. The first thermal interface material has: a first bulk thermal resistance, a contact resistance between the first thermal interface material and the copper substrate, and a contact resistance between the first thermal interface material and the first heat conducting surface. The second thermal interface material comprises: a second layer of carbon nanotubes that are oriented substantially perpendicular to the back surface of the copper substrate, and a second filler material located between carbon nanotubes in the second layer of carbon nanotubes. The second thermal interface material has: a second bulk thermal resistance, a contact resistance between the second thermal interface material and the copper substrate, and a contact resistance between the second thermal interface material and the second heat conducting surface. The summation of the first bulk thermal resistance, the contact resistance between the first thermal interface material and the copper substrate, the contact resistance between the first thermal interface material and the first heat conducting surface, the copper substrate thermal resistance, the second bulk thermal resistance, the contact resistance between the second thermal interface material and the copper substrate, and the contact resistance between the second thermal interface material and the second heat conducting surface has a value of 0.06 cm²K/W or less.

Another aspect of the invention involves an article of manufacture that includes: a heat sink; a copper substrate with a front surface, a back surface, and a copper substrate thermal resistance; and a first thermal interface material attached to the front surface of the copper substrate comprising a first layer of carbon nanotubes and a first filler material located between carbon nanotubes in the first layer of carbon nanotubes. The carbon nanotubes in the first layer of carbon nanotubes are oriented substantially perpendicular to the front surface of the copper substrate. The first thermal interface material has: a first bulk thermal resistance, a contact resistance between the first thermal interface material and the front surface of the copper substrate, and a contact resistance between the first thermal interface material and a solid-state device. The article of manufacture also includes a second thermal interface material attached to the back surface of the copper substrate comprising a second layer of carbon nanotubes and a second filler material located between carbon nanotubes in the second layer of carbon nanotubes. The carbon nanotubes in the second layer of carbon nanotubes are oriented substantially perpendicular to the back surface of the copper substrate. The second thermal interface material has: a second bulk thermal resistance, a contact resistance between the second thermal interface material and the back surface of the copper substrate, and a contact resistance between the second thermal interface material and a heat conducting surface of the heat sink. The summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.06 cm²K/W or less.

Another aspect of the invention involves a method that includes placing a first filler material between carbon nanotubes in a first layer containing carbon nanotubes to form a first thermal interface material. The first thermal interface material has: a first bulk thermal resistance, a contact resistance between the first thermal interface material and a copper substrate, and a contact resistance between the first thermal interface material and a first heat conducting surface. The method also includes placing a second filler material between carbon nanotubes in a second layer containing carbon nanotubes to form a second thermal interface material. The second thermal interface material has: a second bulk thermal resistance, a contact resistance between the second thermal interface material and the copper substrate, and a contact resistance between the second thermal interface material and a second heat conducting surface. The copper substrate has a copper substrate thermal resistance. The summation of the first bulk thermal resistance, the contact resistance between the first thermal interface material and the copper substrate, the contact resistance between the first thermal interface material and the first heat conducting surface, the copper substrate thermal resistance, the second bulk thermal resistance, the contact resistance between the second thermal interface material and the copper substrate, and the contact resistance between the second thermal interface material and the second heat conducting surface has a value of 0.06 cm²K/W or less.

Another aspect of the invention involves an article of manufacture that includes: a solid-state device; a heat sink; a copper substrate with a front surface, a back surface, and a copper substrate thermal resistance; and a first thermal interface material attached to the front surface of the copper substrate and contacting the solid-state device. The first thermal interface material comprises a first layer of carbon nanotubes and a first filler material located between carbon nanotubes in the first layer of carbon nanotubes. The carbon nanotubes in the first layer of carbon nanotubes are oriented substantially perpendicular to the front surface of the copper substrate. The first thermal interface material has: a first bulk thermal resistance, a contact resistance between the first thermal interface material and the copper substrate, and a contact resistance between the first thermal interface material and the solid-state device. The article of manufacture also includes a second thermal interface material attached to the back surface of the copper substrate comprising a second layer of carbon nanotubes and a second filler material located between carbon nanotubes in the second layer of carbon nanotubes. The carbon nanotubes in the second layer of carbon nanotubes are oriented substantially perpendicular to the back surface of the copper substrate. The second thermal interface material has: a second bulk thermal resistance, a contact resistance between the second thermal interface material and the back surface of the copper substrate, and a contact resistance between the second thermal interface material and a heat conducting surface of the heat sink. The summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.06 cm²K/W or less.

Another aspect of the invention involves a method that includes contacting a heat spreader with a first thermal interface material and contacting a heat sink with a second thermal interface material. The first thermal interface material is attached to a front surface of a copper substrate. A back surface of the copper substrate is attached to a second thermal interface material. The second thermal interface material is attached to a heat conducting surface. The first thermal interface material comprises: a first layer of carbon nanotubes that are oriented substantially perpendicular to the front surface of the copper substrate, and a first filler material located between the carbon nanotubes in the first layer of carbon nanotubes. The first thermal interface material has: a first bulk thermal resistance, a contact resistance between the first thermal interface material and the copper substrate, and a contact resistance between the first thermal interface material and the heat spreader. The second thermal interface material comprises: a second layer of carbon nanotubes that are oriented substantially perpendicular to the back surface of the copper substrate, and a second filler material located between the carbon nanotubes in the second layer of carbon nanotubes. The second thermal interface material has: a second bulk thermal resistance, a contact resistance between the second thermal interface material and the copper substrate, and a contact resistance between the second thermal interface material and the heat sink. The summation of the first bulk thermal resistance, the contact resistance between the first thermal interface material and the copper substrate, the contact resistance between the first thermal interface material and the heat spreader, the copper substrate thermal resistance, the second bulk thermal resistance, the contact resistance between the second thermal interface material and the copper substrate, and the contact resistance between the second thermal interface material and the heat sink has a value of 0.06 cm²K/W or less.

One aspect of the invention involves an article of manufacture that includes: a copper substrate with a front surface, a back surface, and a copper substrate thermal resistance; a first catalyst on top of the front surface of the copper substrate; and a first thermal interface material on top of the front surface of the copper substrate. The first thermal interface material comprises: a first layer of carbon nanotubes that contacts the first catalyst, and a first filler material located between the carbon nanotubes in the first layer of carbon nanotubes. The carbon nanotubes in the first layer of carbon nanotubes are oriented substantially perpendicular to the front surface of the copper substrate. The first thermal interface material has: a first bulk thermal resistance, a contact resistance between the first thermal interface material and the copper substrate, and a contact resistance between the first thermal interface material and a first solid-state device. The article of manufacture also includes: a second catalyst on top of the back surface of the copper substrate; and a second thermal interface material on top of the back surface of the copper substrate. The second thermal interface material comprises: a second layer of carbon nanotubes that contacts the second catalyst, and a second filler material located between the carbon nanotubes in the second layer of carbon nanotubes. The carbon nanotubes in the second layer of carbon nanotubes are oriented substantially perpendicular to the back surface of the copper substrate. The second thermal interface material has: a second bulk thermal resistance, a contact resistance between the second thermal interface material and the copper substrate, and a contact resistance between the second thermal interface material and a second solid-state device. The summation of the first bulk thermal resistance, the contact resistance between the first thermal interface material and the copper substrate, the contact resistance between the first thermal interface material and the first solid-state device, the copper substrate thermal resistance, the second bulk thermal resistance, the contact resistance between the second thermal interface material and the copper substrate, and the contact resistance between the second thermal interface material and the second solid-state device has a value of 0.06 cm²K/W or less.

Another aspect of the invention involves a method that includes: forming a first catalyst on top of a front surface of a copper substrate, wherein the copper substrate has a copper substrate thermal resistance; forming a second catalyst on top of a back surface of a copper substrate; growing a first layer containing carbon nanotubes on the first catalyst; growing a second layer containing carbon nanotubes on the second catalyst; placing a first filler material between carbon nanotubes in the first layer containing carbon nanotubes; and placing a second filler material between carbon nanotubes in the second layer containing carbon nanotubes. A first thermal interface material comprises the first layer containing carbon nanotubes and the first filler material. A second thermal interface material comprises the second layer containing carbon nanotubes and the second filler material. The first thermal interface material has: a first bulk thermal resistance, a contact resistance between the first thermal interface material and the copper substrate, and a contact resistance between the first thermal interface material and a first solid-state device. The second thermal interface material has; a second bulk thermal resistance, a contact resistance between the second thermal interface material and the copper substrate, and a contact resistance between the second thermal interface material and a second solid-state device. The summation of the first bulk thermal resistance, the contact resistance between the first thermal interface material and the copper substrate, the contact resistance between the first thermal interface material and the first solid-state device, the copper substrate thermal resistance, the second bulk thermal resistance, the contact resistance between the second thermal interface material and the copper substrate, and the contact resistance between the second thermal interface material and the second solid-state device has a value of 0.06 cm²K/W or less.

Another aspect of the invention involves an article of manufacture that includes: a first solid-state device; a second solid-state device; a copper substrate with a front surface, a back surface, and a copper substrate thermal resistance; and a first thermal interface material attached to the front surface of the copper substrate comprising a first layer of carbon nanotubes and a first filler material located between carbon nanotubes in the first layer of carbon nanotubes. The carbon nanotubes in the first layer of carbon nanotubes are oriented substantially perpendicular to the front surface of the copper substrate. The first thermal interface material has: a first bulk thermal resistance, a contact resistance between the first thermal interface material and the front surface of the copper substrate, and a contact resistance between the first thermal interface material and the first solid-state device. The article of manufacture also includes a second thermal interface material attached to the back surface of the copper substrate comprising a second layer of carbon nanotubes and a second filler material located between carbon nanotubes in the second layer of carbon nanotubes. The carbon nanotubes in the second layer of carbon nanotubes are oriented substantially perpendicular to the back surface of the copper substrate. The second thermal interface material has: a second bulk thermal resistance, a contact resistance between the second thermal interface material and the back surface of the copper substrate, and a contact resistance between the second thermal interface material and the second solid-state device. The summation of the first bulk thermal resistance, the contact resistance between the first thermal interface material and the copper substrate, the contact resistance between the first thermal interface material and the first solid-state device, the copper substrate thermal resistance, the second bulk thermal resistance, the contact resistance between the second thermal interface material and the copper substrate, and the contact resistance between the second thermal interface material and the second solid-state device has a value of 0.06 cm²K/W or less.

Another aspect of the invention involves a method that includes: growing a first layer containing carbon nanotubes on top of a front surface of a copper substrate, wherein the first layer of carbon nanotubes are oriented substantially perpendicular to the front surface of the copper substrate; growing a second layer containing carbon nanotubes on top of a back surface of a copper substrate, wherein the second layer of carbon nanotubes are oriented substantially perpendicular to the back surface of the copper substrate; placing a first filler material between carbon nanotubes in the first layer containing carbon nanotubes; placing a second filler material between carbon nanotubes in the second layer containing carbon nanotubes; contacting a first solid-state device with a first thermal interface material; and contacting a second solid-state device with a second thermal interface material. The copper substrate has a copper substrate thermal resistance. The first thermal interface material comprises the first layer containing carbon nanotubes and the first filler material. The first thermal interface material has: a first bulk thermal resistance, a contact resistance between the first thermal interface material and the copper substrate, and a contact resistance between the first thermal interface material and the first solid-state device. The second thermal interface material comprises the second layer containing carbon nanotubes and the second filler material. The second thermal interface material has: a second bulk thermal resistance, a contact resistance between the second thermal interface material and the copper substrate, and a contact resistance between the second thermal interface material and the second solid-state device. The summation of the first bulk thermal resistance, the contact resistance between the first thermal interface material and the copper substrate, the contact resistance between the first thermal interface material and the first solid-state device, the copper substrate thermal resistance, the second bulk thermal resistance, the contact resistance between the second thermal interface material and the copper substrate, and the contact resistance between the second thermal interface material and the second solid-state device has a value of 0.06 cm²K/W or less.

Another aspect of the invention involves a method that includes placing a first filler material between carbon nanotubes in a first layer containing carbon nanotubes to form a first thermal interface material. The first thermal interface material has: a first bulk thermal resistance, a contact resistance between the first thermal interface material and a copper substrate, and a contact resistance between the first thermal interface material and a first solid-state device. The method also includes placing a second filler material between carbon nanotubes in a second layer containing carbon nanotubes to form a second thermal interface material. The second thermal interface material has: a second bulk thermal resistance, a contact resistance between the second thermal interface material and the copper substrate, and a contact resistance between the second thermal interface material and a second solid-state device. The copper substrate has a copper substrate thermal resistance. The summation of the first bulk thermal resistance, the contact resistance between the first thermal interface material and the copper substrate, the contact resistance between the first thermal interface material and the first solid-state device, the copper substrate thermal resistance, the second bulk thermal resistance, the contact resistance between the second thermal interface material and the copper substrate, and the contact resistance between the second thermal interface material and the second solid-state device has a value of 0.06 cm²K/W or less.

Another aspect of the invention involves an article of manufacture that includes: a first solid-state device; a second solid-state device; a copper substrate with a front surface, a back surface, and a copper substrate thermal resistance; and a first thermal interface material attached to the front surface of the copper substrate and contacting the solid-state device. The first thermal interface material comprises a first layer of carbon nanotubes and a first filler material located between carbon nanotubes in the first layer of carbon nanotubes. The carbon nanotubes in the first layer of carbon nanotubes are oriented substantially perpendicular to the front surface of the copper substrate. The first thermal interface material has: a first bulk thermal resistance, a contact resistance between the first thermal interface material and the copper substrate, and a contact resistance between the first thermal interface material and the first solid-state device. The article of manufacture also includes a second thermal interface material attached to the back surface of the copper substrate comprising a second layer of carbon nanotubes and a second filler material located between carbon nanotubes in the second layer of carbon nanotubes. The carbon nanotubes in the second layer of carbon nanotubes are oriented substantially perpendicular to the back surface of the copper substrate. The second thermal interface material has: a second bulk thermal resistance, a contact resistance between the second thermal interface material and the back surface of the copper substrate, and a contact resistance between the second thermal interface material and the second solid-state device. The summation of the first bulk thermal resistance, the contact resistance between the first thermal interface material and the copper substrate, the contact resistance between the first thermal interface material and the first solid-state device, the copper substrate thermal resistance, the second bulk thermal resistance, the contact resistance between the second thermal interface material and the copper substrate, and the contact resistance between the second thermal interface material and the second solid-state device has a value of 0.06 cm²K/W or less.

Another aspect of the invention involves a method that includes contacting a first solid-state device with a first thermal interface material, and contacting a second solid-state device with a second thermal interface material. The first thermal interface material is attached to a front surface of a copper substrate. The second thermal interface material is attached to a back surface of the copper substrate. The first thermal interface material comprises: a first layer of carbon nanotubes that are oriented substantially perpendicular to the front surface of the copper substrate, and a first filler material located between the carbon nanotubes in the first layer of carbon nanotubes. The first thermal interface material has: a first bulk thermal resistance, a contact resistance between the first thermal interface material and the copper substrate, and a contact resistance between the first thermal interface material and the first solid-state device. The second thermal interface material comprises: a second layer of carbon nanotubes that are oriented substantially perpendicular to the back surface of the copper substrate, and a second filler material located between the carbon nanotubes in the second layer of carbon nanotubes. The second thermal interface material has: a second bulk thermal resistance, a contact resistance between the second thermal interface material and the copper substrate, and a contact resistance between the second thermal interface material and the second solid-state device. The summation of the first bulk thermal resistance, the contact resistance between the first thermal interface material and the copper substrate, the contact resistance between the first thermal interface material and the first solid-state device, the copper substrate thermal resistance, the second bulk thermal resistance, the contact resistance between the second thermal interface material and the copper substrate, and the contact resistance between the second thermal interface material and the second solid-state device has a value of 0.06 cm²K/W or less.

Thus, the present invention provides carbon nanotube-based structures and methods that more efficiently remove beat from IC dies and other solid-state devices. Such structures and methods are compatible with current semiconductor packaging technology, provide low thermal resistances, and are low cost.

### BRIEF DESCRIPTION OF THE DRAWINGS

For a better understanding of the aforementioned aspects of the invention as well as additional aspects and embodiments thereof, reference should be made to the Description of Embodiments below, in conjunction with the following drawings in which like reference numerals refer to corresponding parts throughout the figures. For clarity, features in some figures are not drawn to scale.

FIGS. 1A & 1B are schematic cross sections of articles of manufacture in accordance with some embodiments.

FIG. 2 is a schematic drawing of a copper substrate with thermal interface materials on the front and back surfaces that is configured to contact a heat conducting surface (e.g., a heat spreader) in accordance with some embodiments.

FIG. 3 is a scanning electron microscope image of a layer containing carbon nanotubes in accordance with some embodiments.

FIG. 4A is a Raman spectrum of a layer containing carbon nanotubes in accordance with some embodiments.

FIG. 4B is a schematic diagram of the experimental configuration for obtaining the Raman spectra in FIGS. 4A, 4C & 4D in accordance with some embodiments.

FIG. 4C is a plot of the Raman intensity ratio I_{D}/I_{G} versus thermal performance for layers containing carbon nanotubes, where I_{D} is the intensity of the D peak at ˜1350 cm⁻¹ and I_{G} is the intensity of the G peak at ˜1585 cm⁻¹, in accordance with some embodiments.

FIG. 4D shows Raman spectra of a layer containing carbon nanotubes with and without paraffin between the carbon nanotubes in accordance with some embodiments.

FIG. 5 is a schematic diagram of an experimental configuration for obtaining adhesion data in accordance with some embodiments.

FIG. 6 is a flow diagram illustrating one or more reliability tests that may be applied to carbon nanotube-based structures for removing heat in accordance with some embodiments.

FIG. 7 is a flow diagram illustrating a process for making a copper substrate with thermal interface materials on both the front and back surfaces in accordance with some embodiments.

FIG. 8 is a flow diagram illustrating a process for using a copper substrate with thermal interface materials on both the front and back surfaces in accordance with some embodiments.

FIG. 9 is a schematic cross section of an article of manufacture that includes a heat spreader and a copper substrate with thermal interface materials on both the front and back surfaces in accordance with some embodiments.

FIG. 10 is a flow diagram illustrating a process for making an article of manufacture that includes a heat spreader and a copper substrate with thermal interface materials on both the front and back surfaces in accordance with some embodiments.

FIG. 11A is a flow diagram illustrating a process for placing filler materials between carbon nanotubes in two layers containing carbon nanotubes to form a copper substrate with thermal interface materials on both the front and back surfaces in accordance with some embodiments.

FIG. 11B-11D are flow diagrams illustrating processes for placing a filler material between carbon nanotubes in a layer containing carbon nanotubes to form a thermal interface material in accordance with some embodiments.

FIG. 12 illustrates a side view of an article of manufacture that includes a solid-state device (e.g., an integrated circuit), a heat spreader, and a copper substrate with thermal interface materials on both the front and back surfaces in accordance with some embodiments.

FIG. 13A is a flow diagram illustrating a process for contacting a solid-state device with a first thermal interface material in accordance with some embodiments.

FIG. 13B is a flow diagram illustrating a process for contacting an integrated circuit with a first thermal interface material in accordance with some embodiments.

FIG. 14A-14C illustrate side views of articles of manufacture that include a copper substrate with thermal interface materials on both the front and back surfaces in accordance with some embodiments.

### DESCRIPTION OF EMBODIMENTS

Carbon nanotube-based structures and methods for removing heat from ICs and other solid-state devices are described. As used in the specification and claims, “carbon nanotubes” include carbon nanotubes of varying structural quality, from carbon nanotubes with few defects to carbon nanotubes with many defects (the latter of which are sometimes referred to in the art as “carbon nanofibers”). Thus, as used herein, “carbon nanotubes” include “carbon nanofibers.” Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention as defined by the appended claims.

Moreover, in the following description, numerous specific details are set forth to provide a thorough understanding of the present invention. However, it will be apparent to one of ordinary skill in the art that the invention may be practiced without these particular details. In other instances, methods, procedures, and components that are well known to those of ordinary skill in the art are not described in detail to avoid obscuring aspects of the present invention.

It will be understood that when a layer is referred to as being “on top of” another layer, it can be directly on the other layer or intervening layers may also be present. In contrast, when a layer is referred to as “contacting” another layer, there are no intervening layers present.

It will also be understood that, although the terms first, second, etc. may be used herein to describe various elements, these elements should not be limited by these terms. These terms are only used to distinguish one element from another. For example, a first layer could be termed a second layer, and, similarly, a second layer could be termed a first layer, without departing from the scope of the present invention.

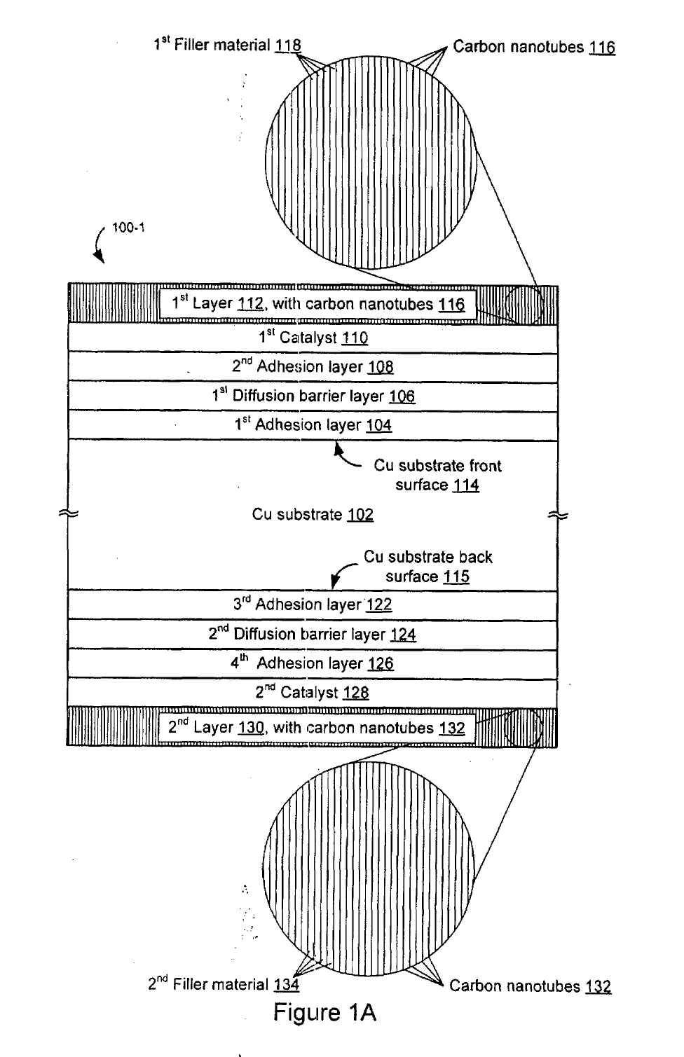

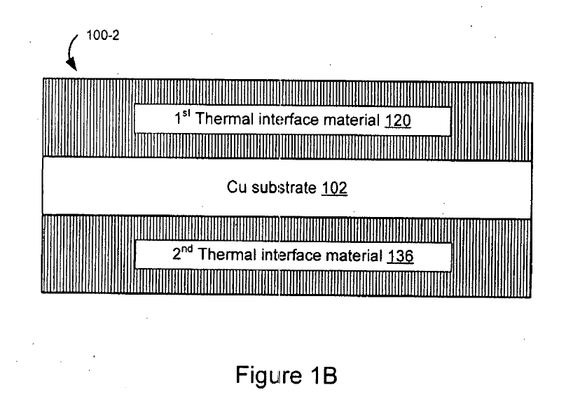

Furthermore, relative terms, such as “lower” or “bottom” and “upper” or “top,” may be used herein to describe one layer's relationship to another layer relative to the substrate surface on which the layers were formed. For example, in FIG. 1A, the first diffusion barrier 106 is on top of the first adhesion layer 104 relative to the front surface 114 of the copper substrate 102. Similarly, in FIG. 1A, the second diffusion barrier 124 is on “top” of the third adhesion layer 122 relative to the back surface 115 of the copper substrate 102, even though the second diffusion barrier 124 is below the third adhesion layer 122 for the orientation of article 100 depicted in FIG. 1A.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The present invention is described below with reference to block diagrams and/or flowchart illustrations of systems, devices, and/or methods according to embodiments of the invention. It should be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the invention.

Unless otherwise defined, all terms used in disclosing embodiments of the invention, including technical and scientific terms, have the same meaning as commonly understood by one of ordinary skill in the art to which this invention belongs, and are not necessarily limited to the specific definitions known at the time of the present invention being described. Accordingly, these terms can include equivalent terms that are created after such time. It will be further understood that terms, such as those defined in commonly used dictionaries, should be interpreted as having a meaning that is consistent with their meaning in the present specification and in the context of the relevant art and will not be interpreted in an idealized or overly formal sense unless expressly so defined herein. All publications, patent applications, patents, and other references mentioned herein are incorporated by reference in their entirety.

FIGS. 1A & 1B are schematic cross sections of articles of manufacture 100 in accordance with some embodiments.

The articles of manufacture 100 comprise a copper substrate 102 with a front surface 114 and a back surface 115. Copper substrate 102 has a thermal resistance, which will be referred to as the “copper substrate thermal resistance” in the specification and claims. The copper substrate 102 may be pure copper (e.g., electrical copper with at least 99.99% purity) or a copper alloy. In some embodiments, the copper substrate 102 contains less than 40 parts per million (ppm) oxygen. In some embodiments, the copper substrate 102 contains 10 ppm oxygen or less. In some embodiments, the copper substrate is oxygen-free copper (OFC). We have found that reducing the amount of oxygen in the substrate increases the uniformity of the carbon nanotubes that are subsequently grown on top of the substrate surfaces.

For clarity, the thicknesses of the layers in FIG. 1A are not drawn to scale. The thin films between the first layer 112 containing carbon nanotubes 116 and the copper substrate 102 (e.g., first adhesion layer 104, first diffusion barrier layer 106, second adhesion layer 108, and first catalyst 110) are much thinner than the first layer 112 containing carbon nanotubes 116 and the copper substrate 102. Similarly, the thin films between the second layer 130 containing carbon nanotubes 132 and the copper substrate 102 (e.g., third adhesion layer 122, second diffusion barrier layer 124, fourth adhesion layer 126, and second catalyst 128) are much thinner than the second layer 130 containing carbon nanotubes 116 and the copper substrate 102. These thin films are not shown in FIG. 1B.

First thermal interface material 120 includes the first layer 112 with carbon nanotubes 116 and a first filler material 118 (e.g. a wax, an ester, an acrylate, a phase change material, or mixtures thereof, as described below) located between the carbon nanotubes in the first layer 112 with carbon nanotubes 116. First thermal interface material 120 may be thicker or thinner than the copper substrate 102.

Similarly, second thermal interface material 136 includes the second layer 130 with carbon nanotubes 132 and a second filler material 134 (e.g. a wax, an ester, an acrylate, a phase change material, or mixtures thereof, as described below) located between the carbon nanotubes in the second layer 130 with carbon nanotubes 132. Second thermal interface material 136 may be thicker or thinner than the copper substrate 102.

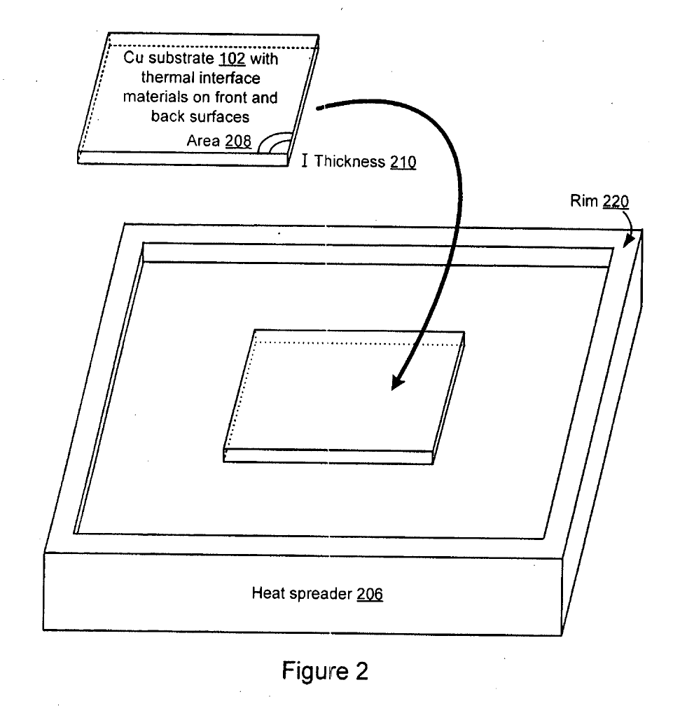

FIG. 2 is a schematic drawing of a copper substrate 102 with thermal interface materials on the front and back surfaces (e.g., 120 and 136) that is configured to contact a heat conducting surface (e.g., heat spreader 206) in accordance with some embodiments.

In some embodiments, the copper substrate 102 has a typical area 208 ranging from 49 mm² (e.g., 7 mm×7 mm) to 2500 mm² (e.g., 50 mm×50 mm). In some embodiments, the copper substrate 102 has a thickness 210 between 5 and 100 microns. In some embodiments, the copper substrate 102 has a thickness 210 between 5 and 25 microns. Thinner copper substrates 102 may simplify the manufacture of heat spreaders and other cooling structures by eliminating the need to make a recessed cavity in the heat spreader to accommodate the copper substrate 102. In some embodiments, the heat spreader 206 is made of copper, a copper alloy, nickel-plated copper, or another high thermal conductivity substrate with a melting point above 900° C. (e.g., CuW, SiC, AlN, or graphite). In some embodiments, the heat spreader 206 does not have a rim 220.

In some embodiments, the copper substrate 102 has a cross-sectional area 208 that substantially corresponds to the cross-sectional area of an integrated circuit or other solid-state device (e.g., a light emitting diode, laser, power transistor, RF device, or solar cell). Thus, the area of the first thermal interface material 120 formed on the copper substrate 102 can be tailored to the corresponding area of an integrated circuit or other solid-state device that will contact the first thermal interface material 120.

In some embodiments, the article of manufacture 100 includes a first adhesion layer 104 that contacts the front surface 114 of the copper substrate 102. The first adhesion layer helps keep subsequent layers firmly attached to the copper substrate. In some embodiments, the first adhesion layer 104 has a thickness between 200 and 5000 Å and comprises Ti, TiN, Cr, or Ta. In some embodiments, the first adhesion layer 104 has a thickness between 200 and 500 Å and comprises Ti.

In some embodiments, the article of manufacture 100 includes a first diffusion barrier layer 106 on top of the first adhesion layer 104. The first diffusion barrier layer minimizes diffusion of a first catalyst 110 into the copper substrate during subsequent high-temperature processing (e.g., during nanotube growth). In some embodiments, the first diffusion barrier layer 106 has a thickness between 100 and 400 Å and comprises TiN, SiO₂, Al₂O₃, or TaN. In some embodiments, the first diffusion barrier layer 106 has a thickness between 100 and 400 Å and comprises TiN.

In some embodiments, the article of manufacture 100 includes a second adhesion layer 108 between the first diffusion barrier layer 106 and the first catalyst 110. Although not required, the second adhesion layer 108 promotes adhesion of the catalyst 110 during subsequent high-temperature processing (e.g., during nanotube growth), when thermal stresses create nucleation sites in the first catalyst 110. In some embodiments, the second adhesion layer 108 has a thickness between 25 and 400 Å and comprises Ti, SiO₂, TiN, Al₂O₃, or Mo. In some embodiments, the second adhesion layer 108 has a thickness between 25 and 200 Å and comprises Ti.

The article of manufacture 100 includes a first catalyst 110 on top of the copper substrate front surface 114. As the name implies, the first catalyst catalyzes growth of the carbon nanotubes 116. The first catalyst is deposited as a layer. The first catalyst layer may subsequently form catalyst particles that act as carbon nanotube nucleation sites during the process used to form carbon nanotubes 116. In some embodiments, the as-deposited first catalyst 110 has a thickness between 30 and 1000 Å and comprises Ni, Fe, or Co. In some embodiments, the as-deposited catalyst 110 has a thickness between 200 and 400 Å and comprises Ni.

The article of manufacture 100 also includes a first layer 112 containing carbon nanotubes 116 that contacts the first catalyst 110. The carbon nanotubes 116 are oriented substantially perpendicular to the front surface 114 of the copper substrate. This orientation minimizes the thermal resistance of the first layer 112 and of first thermal interface materials 120 that include the first layer 112. In some embodiments, the carbon nanotubes 116 comprise multiwalled carbon nanotubes.

In some embodiments, the article of manufacture 100 includes a third adhesion layer 122 that contacts the back surface 115 of the copper substrate 102. The third adhesion layer helps keep subsequent layers firmly attached to the copper substrate. In some embodiments, the third adhesion layer 122 has a thickness between 200 and 5000 Å and comprises Ti, TiN, Cr, or Ta. In some embodiments, the third adhesion layer 122 has a thickness between 200 and 600 Å and comprises Cr.

In some embodiments, the article of manufacture 100 includes a second diffusion barrier layer 124 on top of the third adhesion layer 122. The second diffusion barrier layer minimizes diffusion of a second catalyst 128 into the copper substrate during subsequent high-temperature processing (e.g., during nanotube growth). In some embodiments, the second diffusion barrier layer 124 has a thickness between 100 and 600 Å and comprises TiN, SiO₂, Al₂O₃, or TaN. In some embodiments, the second diffusion barrier layer 124 has a thickness between 400 and 600 Å and comprises SiO₂ or Al₂O₃.

In some embodiments, the article of manufacture 100 includes a fourth adhesion layer 126 between the second diffusion barrier layer 124 and the second catalyst 128. Although not required, the fourth adhesion layer 126 promotes adhesion of the second catalyst 128 during subsequent high-temperature processing (e.g., during nanotube growth), when thermal stresses create nucleation sites in the second catalyst 128. In some embodiments, the fourth adhesion layer 124 has a thickness between 25 and 400 Å and comprises Ti, SiO₂, TiN, Al₂O₃, or Mo. In some embodiments, the fourth adhesion layer 126 has a thickness between 25 and 200 Å and comprises Ti.

The article of manufacture 100 includes a second catalyst 128 on top of the copper substrate back surface 115. As the name implies, the second catalyst catalyzes growth of the carbon nanotubes 132. The second catalyst is deposited as a layer. The second catalyst layer may subsequently form catalyst particles that act as carbon nanotube nucleation sites during the process used to form carbon nanotubes 132. In some embodiments, the as-deposited second catalyst 128 has a thickness between 30 and 1000 Å and comprises Ni, Fe, Co. In some embodiments, the as-deposited second catalyst 128 has a thickness between 30 and 100 Å and comprises Fe.

The article of manufacture 100 also includes a second layer 130 containing carbon nanotubes 132 that contacts the second catalyst 128. The carbon nanotubes 132 are oriented substantially perpendicular to the back surface 115 of the copper substrate. This orientation minimizes the thermal resistance of the second layer 130 and of second thermal interface materials 136 that include the second layer 130. In some embodiments, the carbon nanotubes 132 comprise multiwalled carbon nanotubes.

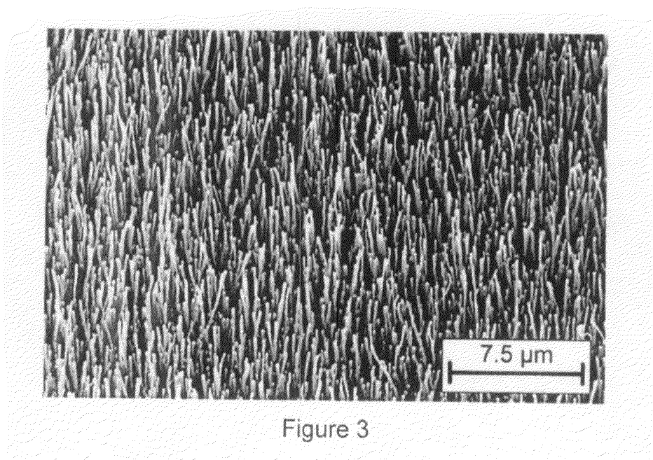

FIG. 3 is a scanning electron microscope image of a layer (e.g., 112 or 130) containing carbon nanotubes in accordance with some embodiments.

In some embodiments, the carbon nanotubes 116 and/or 132 have an average diameter between 60 nm and 200 nm. In some embodiments, the carbon nanotubes 116 and/or 132 have an average diameter between 100 nm and 150 nm. In some embodiments, the carbon nanotubes 116 and/or 132 have an average length between 5 and 50 μm. In some embodiments, the carbon nanotubes 116 and/or 132 have an average length between 20 and 45 μm. In some embodiments, the carbon nanotubes 116 and/or 132 have a tip density between 10 and 40 nanotubes per μm². In some embodiments, the carbon nanotubes 116 and/or 132 have a surface area coverage density between 15 and 40 percent.

In some embodiments, substantially all (e.g., >85%) of the carbon nanotubes 116 and/or 132 are individually separated from each other. Although axial thermal conduction of carbon nanotubes is very high, lateral thermal conduction (in the non-axial direction from nanotube to nanotube) is not as good. In fact, it has been found that lateral contact between axially aligned nanotubes can reduce their effective axial thermal conductivity. If the number of carbon nanotubes attached to substrate is too high (for example, >40% carbon nanotube density) Van der Waals forces will create a bundle or mat situation resulting in poor thermal conduction. If, on the other hand the coverage density is too low (for example, <15%), thermal conduction will also be lower due to the reduced number of conducting nanotubes. A preferred range a coverage density is between about 15 and 40%, with 25 to 40% being most preferred. Thus, vertically aligned, individually separated, parallel carbon nanotubes with coverage between about 15 and 40%, may provide better overall thermal conduction than a bundle or mat of carbon nanotubes.

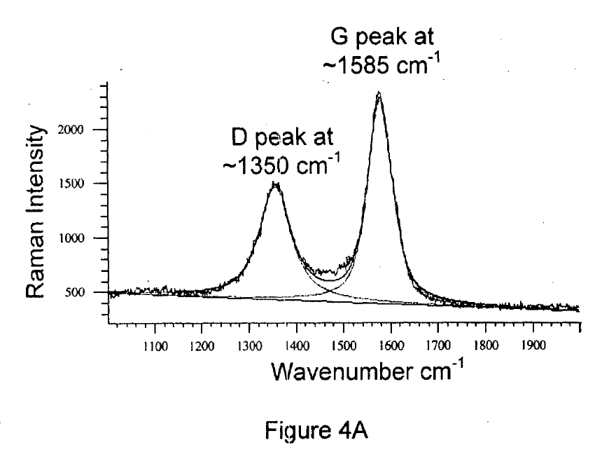

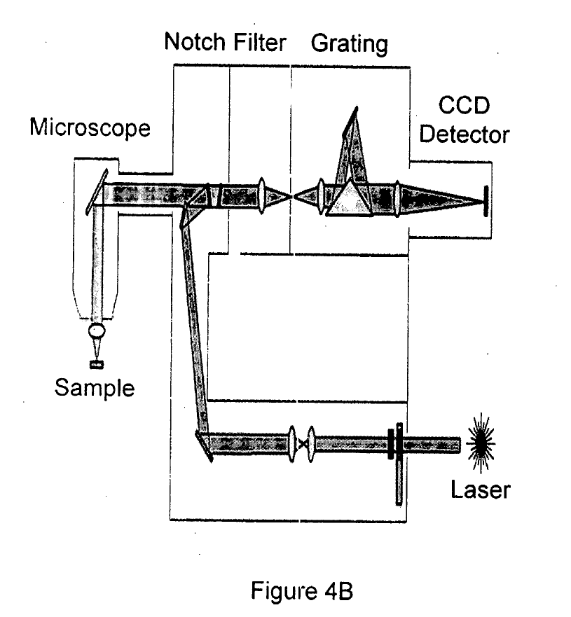

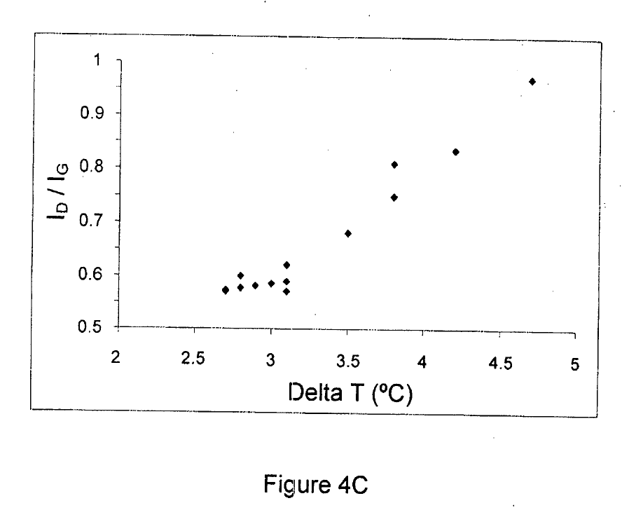

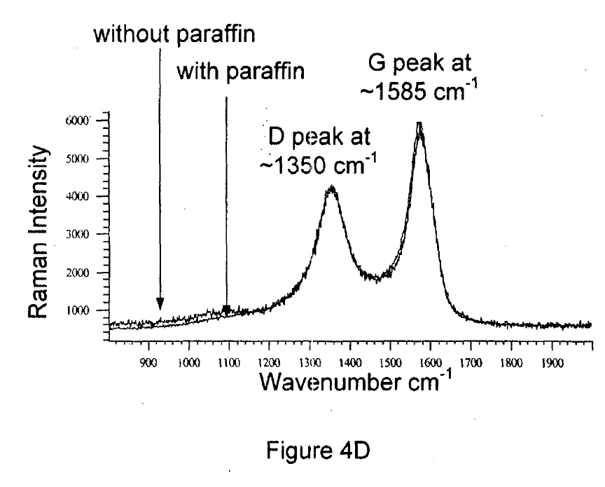

FIG. 4A is a Raman spectrum of a layer containing carbon nanotubes in accordance with some embodiments. The Raman spectrum of the layer (e.g., 112 or 130) containing carbon nanotubes 116 has a D peak at ˜1350 cm⁻¹ with an intensity I_{D} and a G peak at ˜1585 cm⁻¹ with an intensity I_{G}.

FIG. 4B is a schematic diagram of the experimental configuration for obtaining the Raman spectra in FIGS. 4A, 4C & 4D in accordance with some embodiments. A Renishaw in Via Raman microscope with a 514 nm laser beam was used to obtain the Raman spectra. A ˜10 mW, ˜10 μm² laser spot was directed onto the sample with a 50× objective lens. The laser spot was configured to hit the carbon nanotubes in a direction that was parallel to the axes of the carbon nanotubes. The Raman spectra were analyzed using Renishaw WiRE 2.0 software.

FIG. 4C is a plot of the Raman intensity ratio I_{D}/I_{G} versus thermal performance for layers containing carbon nanotubes in accordance with some embodiments. We have found that the thermal performance of the layers (e.g., 112 and/or 130) containing carbon nanotubes depends strongly on the quality of the nanotubes grown, which, in turn, depends on the materials, layers, and growth conditions used. As shown in FIG. 4C, we have also found that Raman spectra from the layer of carbon nanotubes can be used to monitor the quality of the nanotubes. We have found that layers (e.g., 112 and/or 130) with an intensity ratio I_{D}/I_{G} of less than 0.7 at a laser excitation wavelength of 514 nm provide good thermal performance (e.g., 0.06 cm²K/W or less for a 25 μm thick copper substrate with layers 112 and 130, as described below), with an intensity ratio I_{D}/I_{G} of less than 0.6 at a laser excitation wavelength of 514 nm being preferred. In FIG. 4C, the intensity ratio I_{D}/I_{G} is plotted versus the temperature drop (Delta T, ° C.) across an ASTM D 5470 thermal interface material tester containing identical copper substrates with different single layers of carbon nanotubes. As shown in FIG. 4C, the temperature drop decreases (which corresponds to lower thermal resistance) as the I_{D}/I_{G} intensity ratio decreases.

The Raman measurements may be taken with no interstitial (i.e., filler) material (e.g., 118 or 134) between the nanotubes (e.g., before a phase change material is placed between the carbon nanotubes or after such a phase change material is removed from between the carbon nanotubes).

The Raman measurements may also be taken with an interstitial material between the nanotubes if the interstitial material does not interfere with the D peak at ˜1350 cm⁻¹ and the G peak at ˜1585 cm⁻¹. For example, FIG. 4D shows Raman spectra of a layer containing carbon nanotubes with and without paraffin between the carbon nanotubes in accordance with some embodiments. The D and G peaks in the two spectra and the corresponding I_{D}/I_{G} intensity ratios are essentially the same.

In some embodiments, a 25 μm thick copper substrate 102 with: (a) a first thermal interface material 120 comprising the first layer 112 containing carbon nanotubes 116 (e.g., with an average length of 25-45 μm) and first filler material 118 (e.g. a wax, an ester, an acrylate, a phase change material, or mixtures thereof), and (b) a second thermal interface material 136 comprising the second layer 130 containing carbon nanotubes 132 (e.g., with an average length of 25-45 μm) and second filler material 134 (e.g. a wax, an ester, an acrylate, a phase change material, or mixtures thereof) has a thermal resistance of 0.06 cm²K/W or less. This thermal resistance is a summation of: (1) the bulk thermal resistance of the first thermal interface material 120 (termed “the first bulk thermal resistance” in the specification and claims); (2) the contact resistance between the first thermal interface material 120 and the copper substrate 102; (3) the contact resistance between the first thermal interface material 120 and a solid-state device (e.g., an IC) or the equivalent of a solid-state device for testing purposes (e.g., a thermal testing vehicle (TTV) or a heated copper block); (4) the copper substrate thermal resistance (0.0006 cm²K/W for a 25 μm thick copper substrate); (5) the bulk thermal resistance of the second thermal interface material 136 (termed “the second bulk thermal resistance” in the specification and claims); (6) the contact resistance between the second thermal interface material 136 and the copper substrate 102; and (7) the contact resistance between the second thermal interface material 136 and a heat conducting surface (e.g., a surface of a heat spreader or a heat sink). Thus, the summation of (1)-(7) (i.e., the copper substrate thermal resistance, the two bulk thermal resistances of the thermal interface materials 120 & 136, and the four contact resistances associated with the two thermal interface materials 120 & 136) is 0.06 cm²K/W or less. In some embodiments, the summation is 0.05 cm² K/W or less. In some embodiments, the summation is 0.04 cm²K/W or less. In some embodiments, the summation is between 0.035-0.06 cm²K/W. These values are better than what is achieved with conventional thermal interface materials with prior copper substrates with carbon nanotube-based thermal interface materials on both the front and back surfaces.

In testing thermal interface materials, the “solid-state device” referred to in the phrase “contact resistance between the first thermal interface material and a/the solid-state device” may be a thermal test vehicle (TTV, e.g., a non-functional IC package that uses one or more heater resistors to simulate the power dissipation of a live IC), a heated copper block (e.g., in an ASTM D 5470 thermal interface material tester), or other equivalent to a solid-state device for testing purposes. Thus, in the specification and claims, the “contact resistance between the first thermal interface material and a/the solid-state device” includes the contact resistance between the thermal interface material and a solid-state device (e.g., an IC, light emitting diode, laser, power transistor, RF device, or solar cell), a TTV, a copper block in a thermal interface material tester, or other equivalents to a solid-state device for testing purposes.

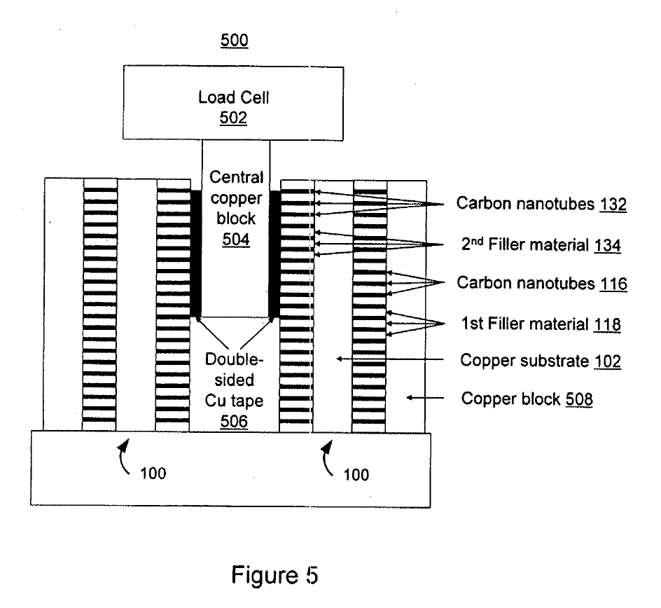

FIG. 5 is a schematic diagram of an experimental configuration 500 for obtaining adhesion data in accordance with some embodiments.

Two samples of article 100, which includes a copper substrate 102, a first thermal interface material 120 (comprising a first layer 112 of carbon nanotubes 116 and first filler material 118), and a second thermal interface material 136 (comprising a second layer 130 of carbon nanotubes 132 and second filler material 134), are: (1) attached to respective copper blocks 508 and (2) attached (e.g., with double sided copper tape 506) to a central copper block 504 in a load cell 502. For a 2 cm×2 cm sample, the tape 506 is typically attached to a 1 cm×2 cm portion of the sample (e.g., the upper half of the samples in FIG. 5). A shearing force is applied by moving the central copper block 504 vertically. The first layer 112 of carbon nanotubes 116 and the second layer 130 of carbon nanotubes 132 are attached to the copper substrate 102. The shearing force needed to detach either the first layer 112 or the second layer 130 of carbon nanotubes from the copper substrate is measured. Typically, the layer of carbon nanotubes in contact with the double sided tape 506 (e.g., the layer 130 of carbon nanotubes 132 in FIG. 5) detaches first, particularly if no filler material (e.g., second filler 134 in FIG. 5) is placed between the carbon nanotubes.

In some embodiments, both the first layer 112 of carbon nanotubes and the second layer 130 of carbon nanotubes can withstand a shearing force of at least 0.5 Kgf without detaching from the copper substrate. In some embodiments, both the first layer 112 of carbon nanotubes and the second layer 130 of carbon nanotubes can withstand a shearing force of at least 3.3 Kgf without detaching from the copper substrate. In some embodiments, both the first layer 112 of carbon nanotubes and the second layer 130 of carbon nanotubes can withstand a shearing force of at least 5 Kgf without detaching from the copper substrate.

The interfacial shearing stress (adhesion) required to detach a layer (e.g., 112 or 130) of carbon nanotubes from the copper substrate may be calculated using the formula:

τₘₐₓ=kT

where τₘₐₓ is the interfacial shear stress (adhesion), k is a constant equal to 0.0422 mm⁻², and T is the measured shearing force required for detachment. Adhesion measurements are discussed in greater detail in U.S. patent application Ser. No. 11/618,441, filed Dec. 29, 2006, entitled “Method and apparatus for the evaluation and improvement of mechanical and thermal properties of CNT/CNF arrays.”

In some embodiments, both the first layer 112 of carbon nanotubes and the second layer 130 of carbon nanotubes can withstand an interfacial shearing stress of at least 30 psi without detaching from the copper substrate. In some embodiments, both the first layer 112 of carbon nanotubes and the second layer 130 of carbon nanotubes can withstand an interfacial shearing stress of at least 200 psi without detaching from the copper substrate. In some embodiments, both the first layer 112 of carbon nanotubes and the second layer 130 of carbon nanotubes can withstand an interfacial shearing stress of at least 300 psi without detaching from the copper substrate.

We have found that adhesion of the two layers containing carbon nanotubes correlates with the overall thermal performance of the article 100. For example, the value of the summation of the copper substrate thermal resistance, the two bulk thermal resistances of the thermal interface materials 120 & 136, and the four contact resistances associated with the two thermal interface materials 120 & 136 is typically greater than 0.10 cm²K/W if either layer of carbon nanotubes fails a tape pull test, whereas the value of the summation is 0.06 cm²K/W or less if both layers of carbon nanotubes pass a tape pull test.

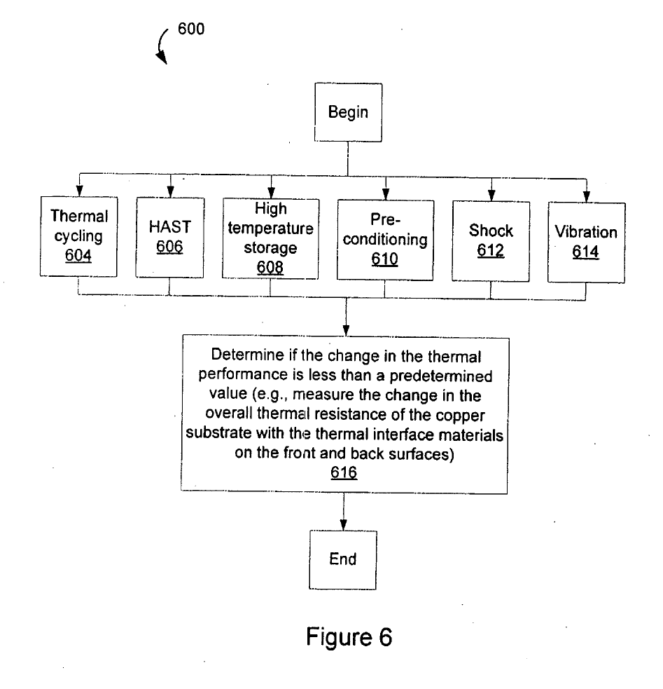

FIG. 6 is a flow diagram illustrating one or more reliability tests that may be applied to carbon nanotube-based structures for removing heat in accordance with some embodiments. It is desirable that carbon nanotube-based structures maintain their thermal performance after being exposed or subjected to harsh environments. These environments may include one or more of:
Temperature cycling 604 (e.g., as described in Joint Electron Device Engineering Council (JEDEC) Standard JESD22-A104C);
Highly-accelerated temperature and humidity stressing (HAST) 606 (e.g., as described in JEDEC Standard JESD22-A110-B);
High temperature storage 608 (e.g., as described in JEDEC Standard JESD22-A103C);
Preconditioning of non-hermetic surface mount devices prior to reliability testing 610 (e.g., as described in JEDEC Standard JESD22A113E);
Mechanical shock 612 (e.g. as described in Military Standard (MIL-STD) 883E, method 2002.3, test condition B); and/or
Vibration 614 (e.g., variable frequency vibration as described in MIL-STD 883E, method 2007.2, test condition A and/or random vibration as described in JEDEC Standard JESD22-B103-B, test condition D).

It is desirable that articles 100 containing the thermal interface materials (e.g., 120 and 136) maintain their overall thermal performance. For example, the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface should change (e.g., increase) by less than a predetermined value (e.g., 5%, 10%, or 15%) after an article containing the thermal interface materials is subjected to one or more of these environments.

In some embodiments, for article 100, the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface changes by less than 15% when the article of manufacture is cycled from −40° C. to 125° C. with a 25° C./min ramp and 5 minute dwell times for 1000 cycles. In some embodiments, the value of the summation changes by less than 10%.

In some embodiments, for article 100, the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface changes by less than 15% when the article of manufacture is heated at 120° C. for 96 hours in 85% relative humidity. In some embodiments, the value of the summation changes by less than 10%.

In some embodiments, for article 100, the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface changes by less than 15% when the article of manufacture is heated at 150° C. for 1000 hours. In some embodiments, the value of the summation changes by less than 10%.

In some embodiments, for article 100, the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface changes by less than 15% when the article of manufacture is: cycled from −40° C. to 125° C. with a 10° C./min ramp and 10 minute dwell times for 5 cycles, then heated at 125° C. for 24 hours, then heated at 30° C. for 192 hours in 60% relative humidity, and then cycled from 25° C. (room temperature) to 260° C. for 3 cycles. In some embodiments, the value of the summation changes by less than 10%.

In some embodiments, for article 100, the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface changes by less than 15% when the article of manufacture is subjected to variable frequency vibration from 20 Hz to 2000 Hz with a peak acceleration of 20 G (e.g., 4 4-minute cycles from 20 Hz to 2000 Hz and back to 20 Hz performed in each of three orthogonal orientations (total of 12 times), so that the motion is applied for a total period of not less than 48 minutes). In some embodiments, the value of the summation changes by less than 10%.

In some embodiments, for article 100, the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface changes by less than 15% when the article of manufacture is subjected to Gaussian random vibration with 1.11 G root mean square (RMS) acceleration, 1.64 in/sec RMS velocity, 0.0310 inches RMS displacement, and 0.186 three sigma peak-to-peak displacement for 30 minutes in each of three orthogonal axes. In some embodiments, the value of the summation changes by less than 10%.

In some embodiments, for article 100, the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface changes by less than 15% when the article of manufacture is subjected to a mechanical shock of 1500 G in a 0.5 ms, half sine wave pulse, with 5 such shocks applied along 6 different axes. In some embodiments, the value of the summation changes by less than 10%.

Prior to this invention, articles containing double layer carbon nanotube-based thermal interface materials had not been reported that could maintain their thermal performance in one or more of the environments described above.

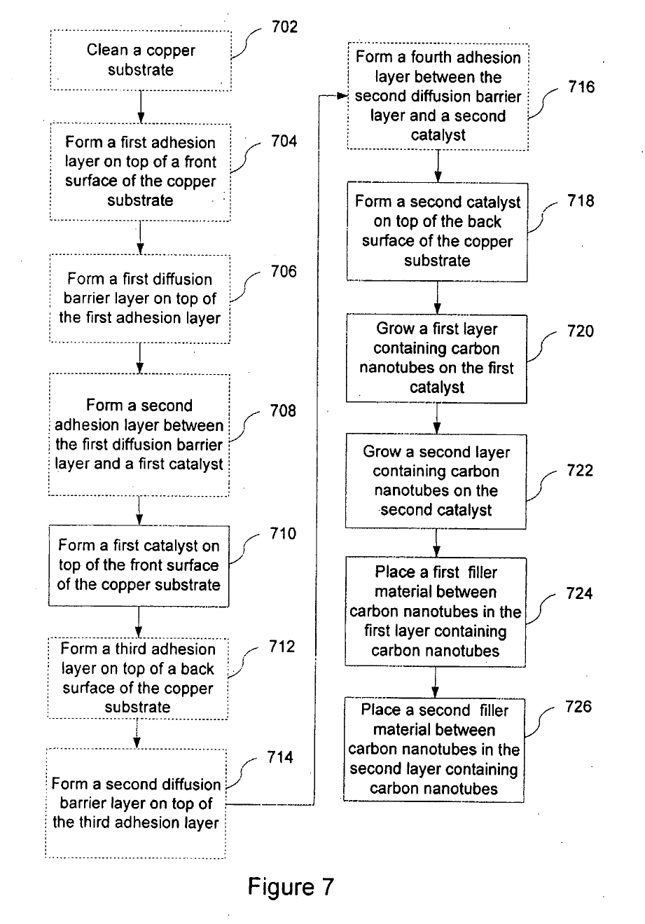

FIG. 7 is a flow diagram illustrating a process for making a copper substrate with thermal interface materials on both the front and back surfaces in accordance with some embodiments.

In some embodiments, a copper substrate 102 is cleaned (702). In some embodiments, the copper substrate 102 is an oxygen-free copper substrate.

In some embodiments, cleaning the copper substrate 102 comprises exposing the substrate 102 to a wet chemical bath. In some embodiments, the wet chemical bath comprises citric acid. In some embodiments, the wet chemical bath is a 100:1 mixture of 5% citric acid and hydrogen peroxide.

In some embodiments, cleaning the copper substrate 102 comprises sputter cleaning the copper substrate.

In some embodiments, a plasma etch step is used to remove contaminants from the copper substrate 102.

We have found that using an oxygen-free copper substrate and thoroughly cleaning the substrate to remove grease, oxides, and other contaminants greatly increases the uniformity and quality of the subsequently grown layers of carbon nanotubes.

Using a thin copper substrate that can be attached after nanotube growth to a heat spreader or other heat conducting surface enables layers of carbon nanotubes to be grown on the copper substrate in an optimum manner, without concern for how the nanotube growth conditions may alter the dimensions, surfaces, and/or mechanical properties of the heat spreader or other heat conducting surface.

In some embodiments, a first adhesion layer 104 is formed (704) on top of a front surface 114 of the copper substrate 102.

In some embodiments, a first diffusion barrier layer 106 is formed (706) on top of the first adhesion layer 104.

In some embodiments, a second adhesion layer 108 is formed (708) between the first diffusion barrier layer 106 and the first catalyst 110. In some embodiments, the second adhesion layer 108 is formed by sputtering.

A first catalyst 110 is formed (710) on top of the front surface 114 of the copper substrate 102.

In some embodiments, the first adhesion layer 104, the first diffusion barrier layer 106 the second adhesion layer 108, and the first catalyst 110 are formed by sputtering. In some embodiments, the first adhesion layer 104, the first diffusion barrier layer 106, the second adhesion layer 108, and the first catalyst 110 are formed by sequentially sputtering each respective layer.

If there is no second adhesion layer 108, in some embodiments, the first adhesion layer 104, the first diffusion barrier layer 106, and the first catalyst 110 are formed by sputtering. If there is no second adhesion layer 108, in some embodiments, the first adhesion layer 104, the first diffusion barrier layer 106, and the first catalyst 110 are formed by sequentially sputtering each respective layer.

Other deposition methods, such as electron beam evaporation, may be used to form the first adhesion layer 104, the first diffusion barrier layer 106, the second adhesion layer 108, and/or the first catalyst 110. The uniformity and thickness of each of these layers, especially the first catalyst 110, is preferably kept within 10% total variation to promote a uniform catalyst nucleation process, which promotes individual separation of carbon nanotubes in the first layer 112 containing carbon nanotubes. In some embodiments, the uniformity and thickness of the first catalyst 110 is kept within 5% total variation.

In some embodiments, a third adhesion layer 122 is formed (712) on top of a back surface 115 of the copper substrate 102.

In some embodiments, a second diffusion barrier layer 124 is formed (714) on top of the third adhesion layer 122.

In some embodiments, a fourth adhesion layer 126 is formed (716) between the second diffusion barrier layer 124 and the second catalyst 128. In some embodiments, the fourth adhesion layer 126 is formed by sputtering.

A second catalyst 128 is formed (718) on top of the back surface 115 of the copper substrate 102.

In some embodiments, the third adhesion layer 122, the second diffusion barrier layer 124, the fourth adhesion layer 126, and the second catalyst 128 are formed by sputtering. In some embodiments, the third adhesion layer 122, the second diffusion barrier layer 124, the fourth adhesion layer 126, and the second catalyst 128 are formed by sequentially sputtering each respective layer.

If there is no fourth adhesion layer 126, in some embodiments, the third adhesion layer 122, the second diffusion barrier layer 124, and the second catalyst 128 are formed by sputtering. If there is fourth adhesion layer 126, in some embodiments, the third adhesion layer 122, the second diffusion barrier layer 124, and the second catalyst 128 are formed by sequentially sputtering each respective layer.

Other deposition methods, such as electron beam evaporation, may be used to form the third adhesion layer 122, the second diffusion barrier layer 124, the fourth adhesion layer 126, and/or the second catalyst 128. The uniformity and thickness of each of these layers, especially the second catalyst 128, is preferably kept within 10% total variation to promote a uniform catalyst nucleation process, which promotes individual separation of carbon nanotubes in the second layer 130 containing carbon nanotubes. In some embodiments, the uniformity and thickness of the second catalyst 128 is kept within 5% total variation.

A first layer 112 containing carbon nanotubes 116 is grown (720) on the first catalyst 110. A second layer 130 containing carbon nanotubes 132 is grown (722) on the second catalyst 128. As is known in the art, carbon nanotubes may form via either tip growth or base growth on the catalyst. As used in the specification and claims, growing carbon nanotubes “on the first/second catalyst” includes tip growth, base growth, or mixtures thereof.

In some embodiments, growing the first layer 112 containing carbon nanotubes and/or second layer 130 containing carbon nanotubes comprises a temperature ramp in an inert atmosphere followed by nanotube growth in a carbon-containing atmosphere.

In some embodiments, the temperature ramp includes ramping the temperature between 600 and 800° C. in 5 minutes or less. In some embodiments, the temperature ramp includes ramping the temperature between 600 and 800° C. in 2 minutes or less. We have found that a fast temperature ramp between 600 and 800° C. promotes a uniform catalyst nucleation process, which promotes individual separation of carbon nanotubes in the layers 112 & 130 containing carbon nanotubes.

In some embodiments, the inert atmosphere comprises argon or nitrogen.

In some embodiments, nanotube growth in the carbon-containing atmosphere comprises plasma-enhanced chemical vapor deposition (PECVD) of carbon nanotubes. In some embodiments, the PECVD comprises flowing NH₃ and C₂H₂ gases over the first catalyst 110 and/or second catalyst 128 at a temperature between 700 and 900° C. in a total pressure between 1 and 10 torr. In some embodiments, the total pressure is between 2 and 4 torr. An electric field created by a DC plasma may be used to align the carbon nanotubes during the PECVD growth process. In some embodiments, nanotube growth in the carbon-containing atmosphere comprises thermal chemical vapor deposition (CVD) of carbon nanotubes. In some embodiments, the thermal CVD comprises flowing NH₃ and C₂H₂ gases over the first catalyst 10 and/or second catalyst 128 at a temperature between 700 and 900° C. in a total pressure between 1 and 10 torr. In some embodiments, the total pressure is between 2 and 4 torr. For both PECVD and thermal CVD, we have found that using NH₃ and a total pressure between 1 and 10 torr improves the quality of the nanotubes and their adhesion to the copper substrate.

In some embodiments, growing (720) the first layer 112 containing carbon nanotubes comprises PECVD of carbon nanotubes and growing (722) the second layer 130 containing carbon nanotubes comprises PECVD of carbon nanotubes. In some embodiments, growing (720) the first layer 112 containing carbon nanotubes comprises PECVD of carbon nanotubes and growing (722) the second layer 130 containing carbon nanotubes comprises thermal chemical vapor deposition of carbon nanotubes. In some embodiments, growing (720) the first layer 112 containing carbon nanotubes comprises thermal chemical vapor deposition of carbon nanotubes and growing (722) the second layer 130 containing carbon nanotubes comprises thermal chemical vapor deposition of carbon nanotubes. In some embodiments, the first layer 112 containing carbon nanotubes and the second layer 130 containing carbon nanotubes are grown simultaneously.

In some embodiments, the carbon nanotubes are annealed after the growth process to release thermal stresses and to remove defects in the nanotube layer (e.g., at temperatures ranging from 700 to 1000° C.).

In some embodiments, a Raman spectrum of the first layer 112 containing carbon nanotubes has a D peak at ˜1350 cm⁻¹ with an intensity I_{D}, a G peak at ˜1585 cm⁻¹ with an intensity I_{G}, and an intensity ratio I_{D}/I_{G} of less than 0.7 at a laser excitation wavelength of 514 nm. In some embodiments, the intensity ratio I_{D}/I_{G} is less than 0.6.

In some embodiments, a Raman spectrum of the second layer 130 containing carbon nanotubes has a D peak at ˜1350 cm⁻¹ with an intensity I_{D}, a G peak at ˜1585 cm⁻¹ with an intensity I_{G}, and an intensity ratio I_{D}/I_{G} of less than 0.7 at a laser excitation wavelength of 514 nm. In some embodiments, the intensity ratio I_{D}/I_{G} is less than 0.6.

A first filler material 118 is placed (724) between carbon nanotubes in the first layer 112 containing carbon nanotubes. A second filler material 134 is placed (726) between carbon nanotubes in the second layer 130 containing carbon nanotubes. In some embodiments, the first filler material 118 and/or the second filler material 134 has one or more of the following properties:
Viscosity between 0.5-100 cSt (at 25° C.), typically 10 cSt—for rapid uptake in the layer containing carbon nanotubes;
Melting point between 30-120° C., preferably between 40-80° C., and most preferably between 50-60° C.;
Thermal conductivity between 0.1-500 W/mK, typically between 0.2-10 W/mK;
Modulus between 50-1000 psi, preferably between 50-150 psi—for better compliance of the thermal interface material;
Boiling point of at least 250° C.;
Surface tension between 1-100 dyne/cm, preferably between 1-20 dynes/cm—with lower values preferred so that the filler material wets the carbon nanotubes.

In some embodiments, the first filler material 118 and/or the second filler material 134 comprises an ester, such as Purester 40 (CH₃—(CH₂)₂₀—COO—(CH₂)₁₇—CH₃, an ester made from stearyl alcohol and methyl behenate by Strahl & Pitsch, http://www.spwax.com/sppure.htm). In some embodiments, the first filler material 118 and/or the second filler material 134 comprises a wax, such as MULTIWAX® W445 Multicrystalline Wax from Gehring-Montgomery, Inc. (http://gehring-montgomery.com/pdfs/MICROCRY.pdf) or paraffin (e.g., C44 paraffin). In some embodiments, the first filler material 118 and/or the second filler material 134 comprises an acrylate. In some embodiments, the first filler material 118 and/or the second filler material 134 comprises a mixture of acrylates. In some embodiments, the first filler material 118 and/or the second filler material 134 comprises a mixture of methyl acrylate, octadecyl acrylate, and acrylic acid. In some embodiments, the first filler material 118 and/or the second filler material 134 comprises a mixture of 0-50% methyl acrylate, 50-90% octadecyl acrylate, and 0-10% acrylic acid. In some embodiments, the first filler material 118 and/or the second filler material 134 comprises a mixture of 27% methyl acrylate, 70% octadecyl acrylate, and 3% acrylic acid. (The preceding percentages are volume percentages.) In some embodiments, the first filler material 118 and/or the second filler material 134 comprises mixtures of esters, waxes, and/or acrylates. In some embodiments, the first filler material 118 and/or the second filler material 134 comprises a conductive filler such as graphene, which may be combined with an ester, wax, and/or acrylate. In some embodiments, the first filler material 118 and/or the second filler material 134 comprises an antioxidant, such as 2′,3-bis[[3-[3,5-di-tert-butyl-4-hydroxyphenyl]propionyl]]propionohydrazide (which goes by the trade name Ciba® RGANOX® MD 1024) or Pentaerythritol Tetrakis(3-(3,5-di-tert-butyl-4, hydroxyphenyl)propionate) (which goes by the trade name Ciba® IRGANOX® 1010). In some embodiments, between 0.5-5% antioxidant improves the long term stability of the first filler material 118 and/or the second filler material 134.

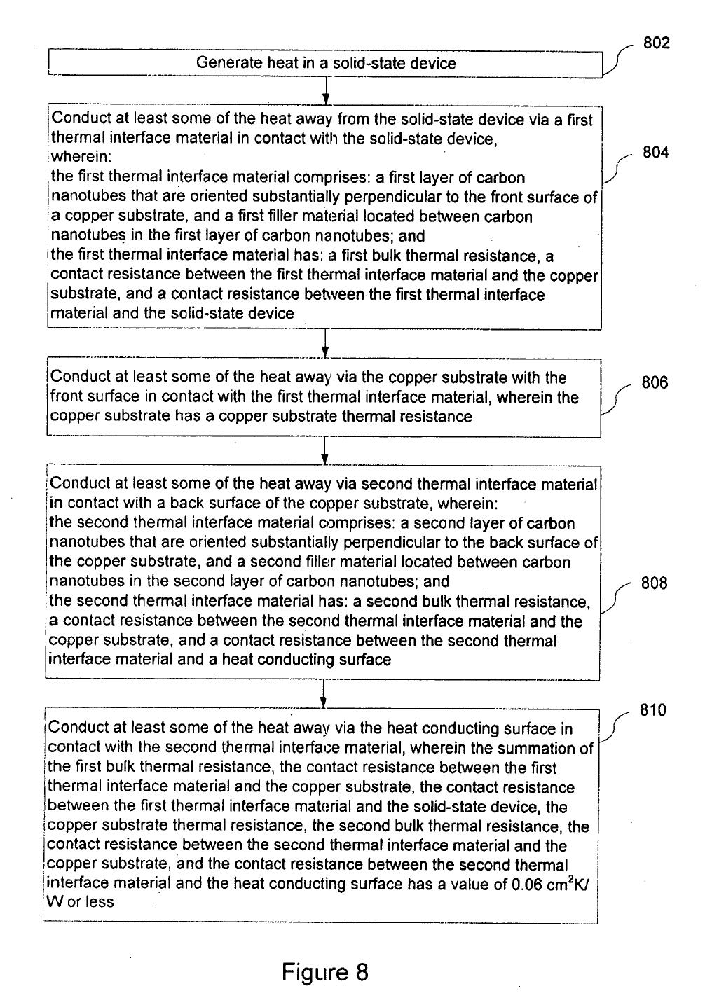

FIG. 8 is a flow diagram illustrating a process for using a copper substrate with thermal interface materials on both the front and back surfaces in accordance with some embodiments.

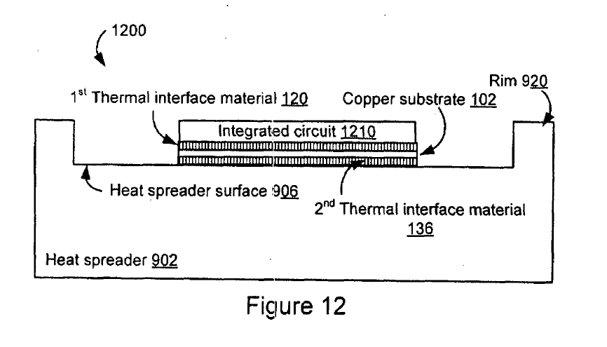

Heat is generated (802) in a solid-state device. In some embodiments, the solid-state device is an integrated circuit (e.g., 1210, FIG. 12).

At least some of the heat is conducted (804) away from the solid-state device via a first thermal interface material 120 in contact with the solid-state device. The first thermal interface material 120 comprises: a first layer 112 of carbon nanotubes 116 that are oriented substantially perpendicular to the front surface 114 of a copper substrate 102, and a first filler material 118 located between carbon nanotubes in the first layer 116 of carbon nanotubes. The first thermal interface material 120 has: a first bulk thermal resistance, a contact resistance between the first thermal interface material 120 and the copper substrate 102, and a contact resistance between the first thermal interface material 120 and the solid-state device.

At least some of the heat is conducted (806) away via the copper substrate 102 with a front surface 114 in contact with the first thermal interface material 120. The copper substrate 102 has a copper substrate thermal resistance.

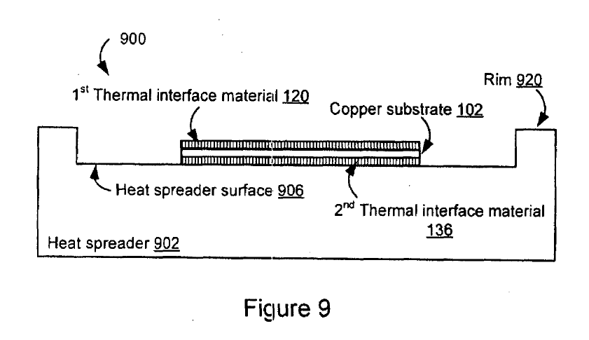

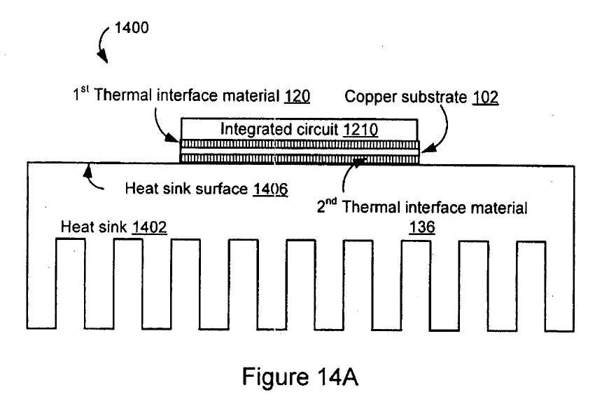

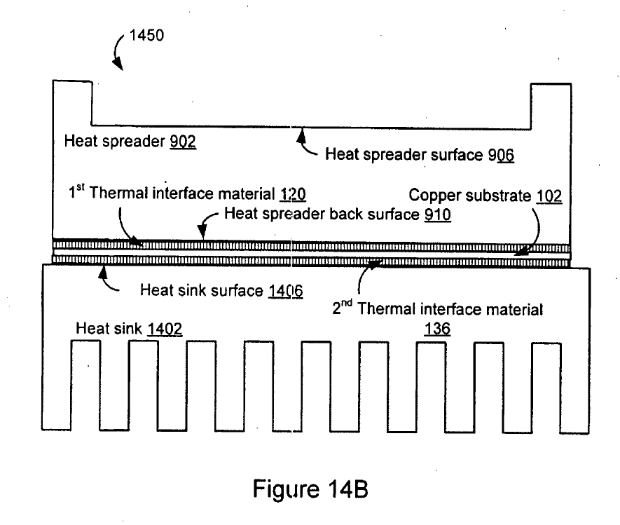

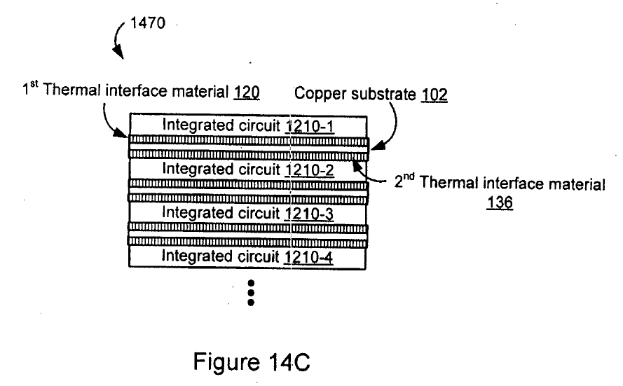

At least some of the heat is conducted (808) away via a second thermal interface material 136 in contact with a back surface 115 of the copper substrate 102. The second thermal interface material 136 comprises: a second layer 130 of carbon nanotubes 132 that are oriented substantially perpendicular to the back surface 115 of the copper substrate, and a second filler material 134 located between carbon nanotubes 132 in the second layer 130 of carbon nanotubes. The second thermal interface material 136 has: a second bulk thermal resistance, a contact resistance between the second thermal interface material 136 and the copper substrate 102, and a contact resistance between the second thermal interface material 136 and a heat conducting surface (e.g., the surface 906 of heat spreader 902, FIG. 9, or the surface 1406 of heat sink 1402, FIG. 14A).

At least some of the heat is conducted (810) away via the heat conducting surface in contact with the second thermal interface material 136.

The summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.06 cm²K/W or less. In some embodiments, the summation is 0.05 cm²K/W or less. In some embodiments, the summation is 0.04 cm²K/W or less. In some embodiments, the summation is between 0.035-0.06 cm²K/W. These values are better than what is achieved with conventional thermal interface materials and with prior copper substrates with carbon nanotube-based thermal interface materials on both the front and back surfaces.

FIG. 9 is a schematic cross section of an article of manufacture 900 that includes a heat spreader 902 and a copper substrate 102 with thermal interface materials 120 & 136 on both the front and back surfaces in accordance with some embodiments.

In some embodiments, the heat spreader 902 does not have a rim 920. In some embodiments, the heat spreader 900 comprises copper or other high-thermal conductivity metal. The copper may comprise pure copper, an alloy containing copper, a mixture containing copper (e.g., Cu—W), and/or a composite containing copper (e.g., Cu—Mo laminate).

The heat spreader 902 has a surface 906 that is configured to face an integrated circuit or other solid-state device.

The copper substrate 102 has a front surface 114 and a back surface 115. In some embodiments, the copper substrate has a thickness between 5 and 100 microns. In some embodiments, the copper substrate has a thickness between 5 and 25 microns. The copper substrate 102 has a copper substrate thermal resistance.

The first thermal interface material 120 is attached to the front surface 114 of the copper substrate 102. The first thermal interface material 120 comprises a first layer 112 of carbon nanotubes 116 and a first filler material 118 located between the carbon nanotubes. The carbon nanotubes 116 are oriented substantially perpendicular to the front surface 114 of the copper substrate 102. In some embodiments, substantially all of the carbon nanotubes 116 are individually separated from each other.

The second thermal interface material 136 is attached to the back surface 115 of the copper substrate 102. The second thermal interface material 136 comprises a second layer 130 of carbon nanotubes 132 and a second filler material 134 located between the carbon nanotubes. The carbon nanotubes 132 are oriented substantially perpendicular to the back surface 115 of the copper substrate 102. In some embodiments, substantially all of the carbon nanotubes 132 are individually separated from each other.

In some embodiments, a Raman spectrum of the first layer 112 containing carbon nanotubes has a D peak at ˜1350 cm⁻¹ with an intensity I_{D}, a G peak at ˜1585 cm⁻¹ with an intensity I_{G}, and an intensity ratio I_{D}/I_{G} of less than 0.7 at a laser excitation wavelength of 514 nm. In some embodiments, the intensity ratio I_{D}/I_{G} is less than 0.6.

In some embodiments, a Raman spectrum of the second layer 130 containing carbon nanotubes has a D peak at ˜1350 cm⁻¹ with an intensity I_{D}, a G peak at ˜1585 cm⁻¹ with an intensity I_{G}, and an intensity ratio I_{D}/I_{G} of less than 0.7 at a laser excitation wavelength of 514 nm. In some embodiments, the intensity ratio I_{D}/I_{G} is less than 0.6.

In some embodiments, the first layer 112 of carbon nanotubes 116 is attached to the front surface of the copper substrate 102 by growing the carbon nanotubes on the front surface of the copper substrate and the second layer 130 of carbon nanotubes is attached to the back surface of the copper substrate by growing carbon nanotubes on the back surface of the copper substrate. In some embodiments, as described above, both the first layer 112 of carbon nanotubes and the second layer 130 of carbon nanotubes can withstand a shearing force of at least 0.5 Kgf without detaching from the copper substrate. In some embodiments, both the first layer 112 of carbon nanotubes and the second layer 130 of carbon nanotubes can withstand a shearing force of at least 3.3 Kgf without detaching from the copper substrate. In some embodiments, both the first layer 112 of carbon nanotubes and the second layer 130 of carbon nanotubes can withstand a shearing force of at least 5 Kgf without detaching from the copper substrate.

In some embodiments, as described above, both the first layer 112 of carbon nanotubes and the second layer 130 of carbon nanotubes can withstand an interfacial shearing stress of at least 30 psi without detaching from the copper substrate. In some embodiments, both the first layer 112 of carbon nanotubes and the second layer 130 of carbon nanotubes can withstand an interfacial shearing stress of at least 200 psi without detaching from the copper substrate. In some embodiments, both the first layer 112 of carbon nanotubes and the second layer 130 of carbon nanotubes can withstand an interfacial shearing stress of at least 300 psi without detaching from the copper substrate.

In some embodiments, the first filler material 118 and/or the second filler material 134 comprises a phase change material. In some embodiments, the first filler material 118 and/or the second filler material 134 comprises an ester, a wax, or an acrylate. In some embodiments, the phase change material comprises paraffin. We believe that filler materials: improve the thermal performance of the first thermal interface material 120 by filling the air gap between carbon nanotubes with lengths that do not make thermal contact with an opposing IC or other solid-state device surface; improve the thermal performance of the second thermal interface material 136 by filling the air gap between carbon nanotubes with lengths that do not make thermal contact with the heat spreading surface; and improve the thermal performance of the first thermal interface material 120 and the second thermal interface material 136 by wetting and separating the carbon nanotubes when pressed to conform with asperities on the opposing surface. In addition, we believe that a thin, conformable copper substrate 102 increases the number of carbon nanotubes making contact with an opposing solid-state device and/or heat conducting surface, thereby reducing the corresponding contact resistances.

In some embodiments, as described above, the first filler material 118 and/or the second filler material 134 comprises an ester, such as Purester 40 (CH₃—(CH₂)₂₀—COO—(CH₂)₁₇—CH₃, an ester made from stearyl alcohol and methyl behenate by Strahl & Pitsch, http://www.spwax.com/sppure.htm). In some embodiments, the first filler material 118 and/or the second filler material 134 comprises a wax, such as WULTIWAX® W445 Multicrystalline Wax from Gehring-Montgomery, Inc. (http://gehring-montgomery.com/pdfs/MICROCRY.pdf) or paraffin (e.g., C44 paraffin). In some embodiments, the first filler material 118 and/or the second filler material 134 comprises an acrylate. In some embodiments, the first filler material 118 and/or the second filler material 134 comprises a mixture of acrylates. In some embodiments, the first filler material 118 and/or the second filler material 134 comprises a mixture of methyl acrylate, octadecyl acrylate, and acrylic acid. In some embodiments, the first filler material 118 and/or the second filler material 134 comprises a mixture of 0-50% methyl acrylate, 50-90% octadecyl acrylate, and 0-10% acrylic acid. In some embodiments, the first filler material 118 and/or the second filler material 134 comprises a mixture of 27% methyl acrylate, 70% octadecyl acrylate, and 3% acrylic acid. (The preceding percentages are volume percentages.) In some embodiments, the first filler material 118 and/or the second filler material 134 comprises mixtures of esters, waxes, and/or acrylates. In some embodiments, the first filler material 118 and/or the second filler material 134 comprises a conductive filler such as graphene, which may be combined with an ester, wax, and/or acrylate. In some embodiments, the first filler material 118 and/or the second filler material 134 comprises an antioxidant, such as 2′,3-bis[[3-[3,5-di-tert-butyl-4-hydroxyphenyl]propionyl]]propionohydrazide (which goes by the trade name Ciba® IRGANOX® MD 1024) or Pentaerythritol Tetrakis(3-(3,5-di-tert-butyl-4-hydroxyphenyl)propionate) (which goes by the trade name Ciba® IRGANOX® 1010). In some embodiments, between 0.5-5% antioxidant improves the long term stability of the first filler material 118 and/or the second filler material 134.

As described above, for the copper substrate 102 with thermal interface materials 120 & 136 on the front and back surfaces, respectively, the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface (e.g., heat spreader surface 906, or heat sink surface 1406) has a value of 0.06 cm²K/W or less. In some embodiments, the summation is 0.05 cm² K/W or less. In some embodiments, the summation is 0.04 cm²K/W or less. In some embodiments, the summation is between 0.035-0.06 cm²K/W. These values are better than what is achieved with conventional thermal interface materials and with prior copper substrates with carbon nanotube-based thermal interface materials on both the front and back surfaces.

In some embodiments, as described above with respect to FIG. 6, the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface changes (e.g., increases) by less than a predetermined value (e.g., 5%, 10%, or 15%) after the copper substrate 102 with thermal interface materials 120 & 136 on the front and back surfaces, respectively, is subjected to one or more harsh environments (e.g., thermal cycling 604, HAST 606, high temperature storage 608, preconditioning 610, shock 612, and/or vibration 614).

The article of manufacture 900 may be reworkable, which increases yields and reduces manufacturing costs. In some embodiments, an integrated circuit or other solid-state device may be removably connected to the first thermal interface material 120. In some embodiments, the first thermal interface material 120 is configured to enable an integrated circuit or other solid-state device to be connected to the first thermal interface material, disconnected from the first thermal interface material, and then reconnected to the first thermal interface material. In some embodiments, the article of manufacture 900 is configured to be reused to cool a succession of integrated circuits or other solid-state devices.

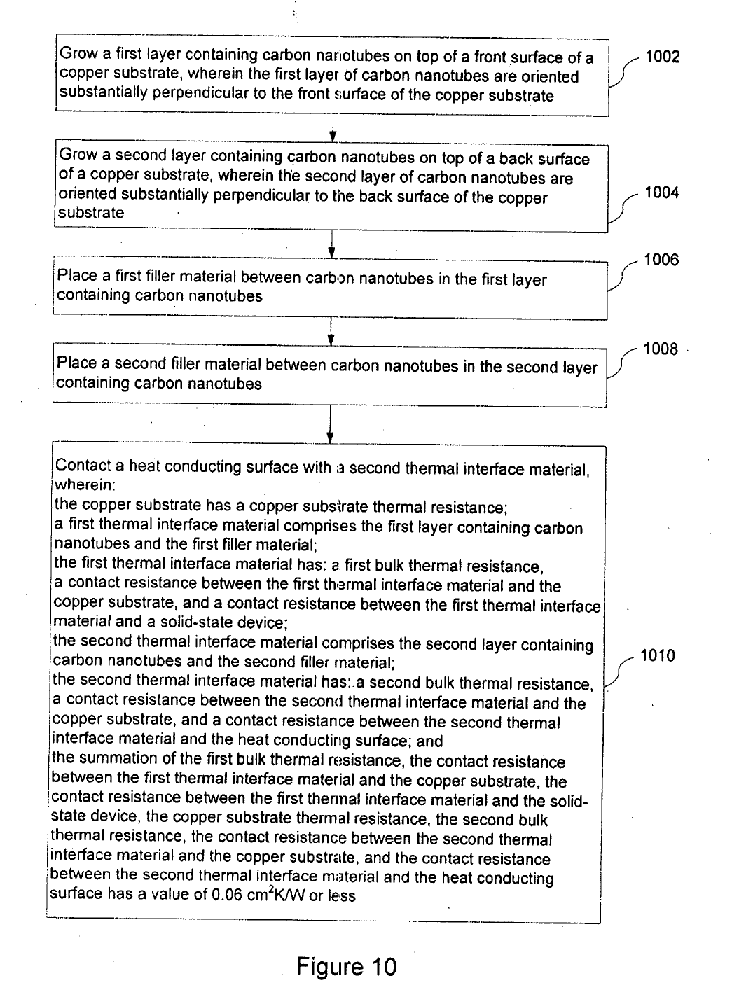

FIG. 10 is a flow diagram illustrating a process for making an article of manufacture 906 that includes a heat spreader 902 and a copper substrate 102 with thermal interface materials on both the front and back surfaces in accordance with some embodiments.

A first layer 112 containing carbon nanotubes 116 is grown (1002) on top of a front surface 114 of a copper substrate 102 (e.g., as described above with respect to FIG. 7). The first layer of carbon nanotubes are oriented substantially perpendicular to the front surface of the copper substrate. The copper substrate has a copper substrate thermal resistance.

A second layer 130 containing carbon nanotubes 132 is grown (1004) on top of a back surface 115 of a copper substrate 102 (e.g., as described above with respect to FIG. 7). The second layer of carbon nanotubes are oriented substantially perpendicular to the back surface of the copper substrate.

In some embodiments, a Raman spectrum of the first layer 112 containing carbon nanotubes has a D peak at ˜1350 cm⁻¹ with an intensity I_{D}, a G peak at ˜1585 cm⁻¹ with an intensity I_{G}, and an intensity ratio I_{D}/I_{G} of less than 0.7 at a laser excitation wavelength of 514 nm. In some embodiments, the intensity ratio I_{D}/I_{G} is less than 0.6.

In some embodiments, a Raman spectrum of the second layer 130 containing carbon nanotubes has a D peak at ˜1350 cm⁻¹ with an intensity I_{D}, a G peak at ˜1585 cm⁻¹ with an intensity I_{G}, and an intensity ratio I_{D}/I_{G}, of less than 0.7 at a laser excitation wavelength of 514 nm. In some embodiments, the intensity ratio I_{D}/I_{G} is less than 0.6.

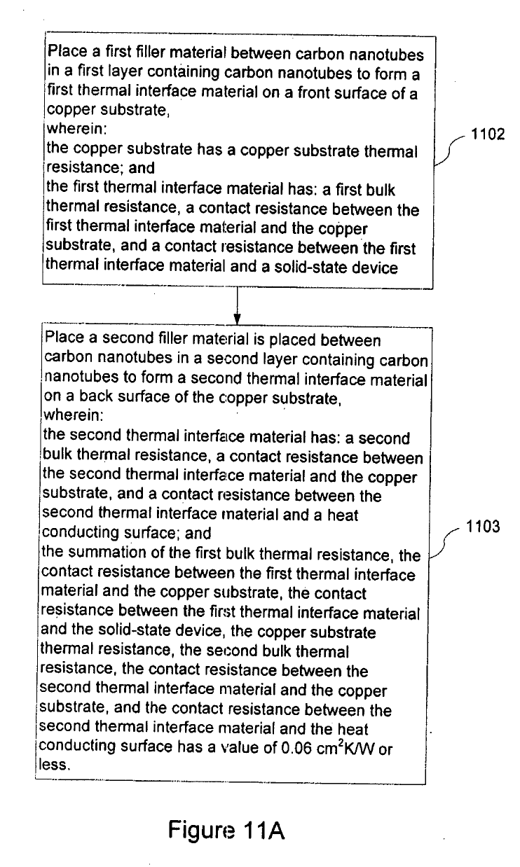

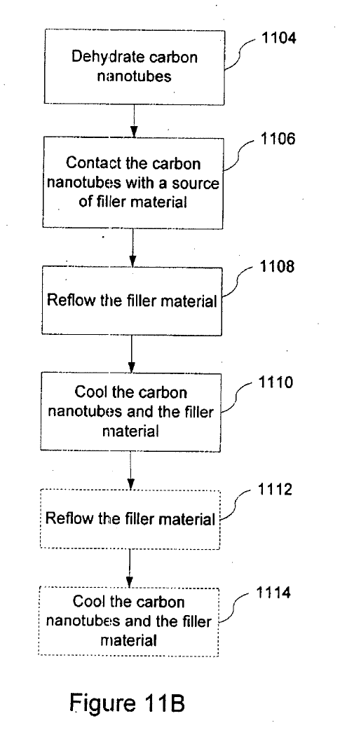

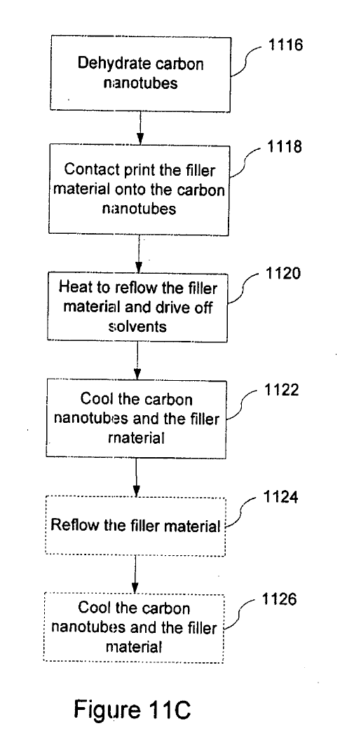

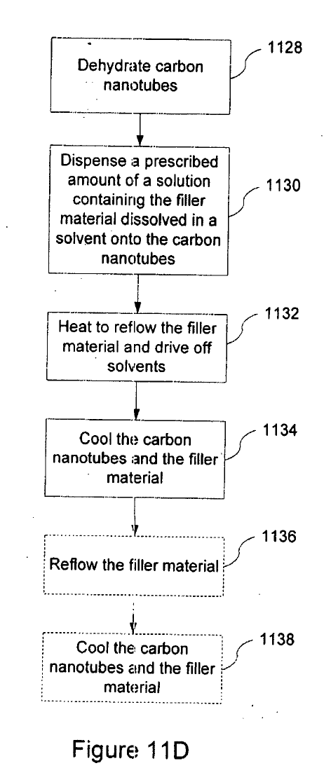

A first filler material 118 is placed (1006) between carbon nanotubes in the first layer 112 containing carbon nanotubes. In some embodiments, the first filler material comprises an ester, a wax, an acrylate, or mixtures thereof, as described above. In some embodiments, placing the first filler material between carbon nanotubes in the first layer containing carbon nanotubes comprises the process discussed below with respect to FIG. 11B, the process discussed below with respect to FIG. 11C, or the process discussed below with respect to FIG. 11D.

A first thermal interface material 120 comprises the first layer 112 containing carbon nanotubes 116 and the first filler material 118. The first thermal interface material has: a first bulk thermal resistance, a contact resistance between the first thermal interface material and the copper substrate, and a contact resistance between the first thermal interface material and a solid-state device.

A second filler material 134 is placed (1008) between carbon nanotubes in the second layer 130 containing carbon nanotubes (e.g., as described above with respect to FIG. 7). In some embodiments, the second filler material comprises an ester, a wax, an acrylate, or mixtures thereof, as described above. In some embodiments, placing the second filler material between carbon nanotubes in the second layer containing carbon nanotubes comprises the process discussed below with respect to FIG. 11B, the process discussed below with respect to FIG. 1 IC, or the process discussed below with respect to FIG. 11D.

A second thermal interface material 136 comprises the second layer 130 containing carbon nanotubes and the second filler material 134. The second thermal interface material has: a second bulk thermal resistance, a contact resistance between the second thermal interface material and the copper substrate, and a contact resistance between the second thermal interface material and a heat conducting surface (e.g., heat spreader surface 906 or heat sink surface 1406).

The heat conducting surface is contacted (1010) with the second thermal interface material 136.

The summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.06 cm²K/W or less. In some embodiments, the summation is 0.05 cm²K/W or less. In some embodiments, the summation is 0.04 cm²K/W or less. In some embodiments, the summation is between 0.035-0.06 cm²K/W. These values are better than what is achieved with conventional thermal interface materials and with prior copper substrates with carbon nanotube-based thermal interface materials on both the front and back surfaces.

FIG. 11A is a flow diagram illustrating a process for placing filler materials 118 & 134 between carbon nanotubes in two layers containing carbon nanotubes to form a copper substrate with thermal interface materials on both the front and back surfaces in accordance with some embodiments.

A first filler material 118 is placed (1102) between carbon nanotubes 116 in a first layer 112 containing carbon nanotubes to form a first thermal interface material 120 on a front surface 114 of a copper substrate 102. The copper substrate 102 has a copper substrate thermal resistance. The first thermal interface material 120 has: a first bulk thermal resistance, a contact resistance between the first thermal interface material and the copper substrate, and a contact resistance between the first thermal interface material and a solid-state device.

A second filler material 134 is placed (1103) between carbon nanotubes 132 in a second layer 130 containing carbon nanotubes to form a second thermal interface material 136 on a back surface 115 of the copper substrate 102. The second thermal interface material 136 has: a second bulk thermal resistance, a contact resistance between the second thermal interface material and the copper substrate, and a contact resistance between the second thermal interface material and a heat conducting surface (e.g., heat spreader surface 906 or heat sink surface 1406).

The summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.06 cm²K/W or less. In some embodiments, the summation is 0.05 cm²K/W or less. In some embodiments, the summation is 0.04 cm²K/W or less. In some embodiments, the summation is between 0.035-0.06 cm²K/W. These values are better than what is achieved with conventional thermal interface materials and with prior copper substrates with carbon nanotube-based thermal interface materials on both the front and back surfaces.

In some embodiments, as described above with respect to FIG. 6, the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface changes (e.g., increases) by less than a predetermined value (e.g., 5%, 10%, or 15%) after the copper substrate 102 with thermal interface materials 120 & 136 on the front and back surfaces, respectively, is subjected to one or more harsh environments (e.g., thermal cycling 604, HAST 606, high temperature storage 608, preconditioning 610, shock 612, and/or vibration 614).

In some embodiments, a Raman spectrum of the first layer 112 containing carbon nanotubes has a D peak at ˜1350 cm⁻¹ with an intensity I_{D}, a G peak at ˜1585 cm⁻¹ with an intensity I_{G}, and an intensity ratio I_{D}/I_{G} of less than 0.7 at a laser excitation wavelength of 514 nm. In some embodiments, the intensity ratio I_{D}/I_{G} is less than 0.6.

In some embodiments, a Raman spectrum of the second layer 130 containing carbon nanotubes has a D peak at ˜1350 cm⁻¹ with an intensity I_{D}, a G peak at ˜1585 cm⁻¹ with an intensity I_{G}, and an intensity ratio I_{D}/I_{G} of less than 0.7 at a laser excitation wavelength of 514 nm. In some embodiments, the intensity ratio I_{D}/I_{G}; is less than 0.6.

FIG. 11B is a flow diagram illustrating a process for placing a filler material between carbon nanotubes in a layer containing carbon nanotubes to form a thermal interface material in accordance with some embodiments (e.g., placing a first filler material 118 between carbon nanotubes 116 in a first layer 112 containing carbon nanotubes to form a first thermal interface material 120 or placing a second filler material 134 between carbon nanotubes 132 in a second layer 1.30 containing carbon nanotubes to form a second thermal interface material 136). In some embodiments, the placing comprises:

dehydrating (1104) the carbon nanotubes (e.g., by placing an article with the layer containing carbon nanotubes on a heated surface at 100° C. for 5 minutes);

contacting (1106) the carbon nanotubes with a source of filler material (e.g., for paraffin wax, pressing a pre-waxed paper on to the tips of the carbon nanotubes with a flat surface at a temperature above the melting point of the paraffin wax);

reflowing (1108) the filler material;

cooling (1110) the carbon nanotubes and filler material (e.g., by quenching on a metal block); and

optionally, reflowing (1112) the filler material again and cooling (1114) the carbon nanotubes and filler material one or more additional times.

FIG. 11C is a flow diagram illustrating a process for placing a filler material between carbon nanotubes in a layer containing carbon nanotubes to form a thermal interface material in accordance with some embodiments (e.g., placing a first filler material 118 between carbon nanotubes 116 in a first layer 112 containing carbon nanotubes to form a first thermal interface material 120 or placing a second filler material 134 between carbon nanotubes 132 in a second layer 130 containing carbon nanotubes to form a second thermal interface material 136). In some embodiments, the placing comprises:

dehydrating (1116) the carbon nanotubes (e.g., by placing an article with the layer containing carbon nanotubes on a heated surface at 100° C. for 5 minutes);

contact printing (1118) the filler material onto the carbon nanotubes (e.g., using a silicon stamp and a filler material reservoir to transfer a prescribed amount of filler material from the stamp to the carbon nanotubes);

heating (1120) to reflow the filler material and drive off solvents (e.g., in a vacuum oven);

cooling (1122) the carbon nanotubes and filler material (e.g., by quenching on a metal block); and

optionally, reflowing (1124) the filler material again and cooling (1126) the carbon nanotubes and filler material one or more additional times.

FIG. 11D is a flow diagram illustrating a process for placing a filler material between carbon nanotubes in a layer containing carbon nanotubes to form a thermal interface material in accordance with some embodiments (e.g., placing a first filler material 118 between carbon nanotubes 116 in a first layer 112 containing carbon nanotubes to form a first thermal interface material 120 or placing a second filler material 134 between carbon nanotubes 132 in a second layer 130 containing carbon nanotubes to form a second thermal interface material 136). In some embodiments, the placing comprises:

dehydrating (1128) the carbon nanotubes (e.g., by placing an article with the layer containing carbon nanotubes on a heated surface at 100° C. for 5 minutes);

dispensing (1130) a prescribed amount of a solution containing the filler material dissolved in a solvent (e.g., a solution containing the filler material and the solvent in a ratio between 1:10 and 1:500) onto the carbon nanotubes;

heating (1132) to reflow the filler material and drive off solvents (e.g., in a vacuum oven);

cooling (1134) the carbon nanotubes and filler material (e.g., by quenching on a metal block); and

optionally, reflowing (1136) the filler material again and cooling (1138) the carbon nanotubes and filler material one or more additional times.

FIG. 12 illustrates a side view of an article of manufacture 1200 that includes a solid-state device (e.g., integrated circuit 1210), a heat spreader 902, and a copper substrate 102 with thermal interface materials on both the front and back surfaces in accordance with some embodiments. The printed circuit board or other substrate that the integrated circuit 1210 is attached to is omitted for clarity. Article 1200 can further include additional components (not shown).

The copper substrate 102 has a front surface 114 and a back surface 115. The copper substrate 102 has a copper substrate thermal resistance. The heat spreader 902 has a surface 906 facing the integrated circuit 1210.

A first thermal interface material 120 is attached to the front surface 114 of the copper substrate 102 and contacts the solid-state device (e.g., integrated circuit 1210). The first thermal interface material 120 comprises a first layer 112 of carbon nanotubes 116 and a first filler material 118 located between carbon nanotubes in the first layer of carbon nanotubes. The carbon nanotubes 116 in the first layer of carbon nanotubes are oriented substantially perpendicular to the front surface of the copper substrate. The first thermal interface material 120 has: a first bulk thermal resistance, a contact resistance between the first thermal interface material and the copper substrate, and a contact resistance between the first thermal interface material and the solid-state device.

A second thermal interface material 136 is attached to the back surface 115 of the copper substrate 102. The second thermal interface material 136 comprises a second layer 130 of carbon nanotubes 132 and a second filler material 134 located between carbon nanotubes in the second layer of carbon nanotubes. The carbon nanotubes 132 in the second layer of carbon nanotubes are oriented substantially perpendicular to the back surface of the copper substrate. The second thermal interface material 136 has: a second bulk thermal resistance, a contact resistance between the second thermal interface material and the back surface of the copper substrate, and a contact resistance between the second thermal interface material and a heat conducting surface (e.g., heat spreader surface 906 or heat sink surface 1406).

The summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.06 cm²K/W or less. In some embodiments, the summation is 0.05 cm²K/W or less. In some embodiments, the summation is 0.04 cm²K/W or less. In some embodiments, the summation is between 0.035-0.06 cm²K/W. These values are better than what is achieved with conventional thermal interface materials and with prior copper substrates with carbon nanotube-based thermal interface materials on both the front and back surfaces.

In some embodiments, the copper substrate has a thickness between 5 and 100 microns. In some embodiments, the copper substrate has a thickness between 5 and 25 microns.

In some embodiments, first filler material 118 and/or the second filler material 134 comprises a phase change material. In some embodiments, first filler material 118 and/or the second filler material 134 comprises an ester, a wax, or an acrylate.

In some embodiments, as described above, the first filler material 118 and/or the second filler material 134 comprises an ester, such as Purester 40 (CH₃—(CH₂)₂₀—COO—(CH₂)₁₇—CH₃, an ester made from stearyl alcohol and methyl behenate by Strahl & Pitsch, http://www.spwax.com/sppure.htm). In some embodiments, the first filler material 118 and/or the second filler material 134 comprises a wax, such as MULTiWAX® W445 Multicrystalline Wax from Gehring-Montgomery, Inc. (http://gehring-montgomery.com/pdfs/MICROCRY.pdf) or paraffin (e.g., C44 paraffin). In some embodiments, the first filler material 118 and/or the second filler material 134 comprises an acrylate. In some embodiments, the first filler material 118 and/or the second filler material 134 comprises a mixture of acrylates. In some embodiments, the first filler material 118 and/or the second filler material 134 comprises a mixture of methyl acrylate, octadecyl acrylate, and acrylic acid. In some embodiments, the first filler material 118 and/or the second filler material 134 comprises a mixture of 0-50% methyl acrylate, 50-90% octadecyl acrylate, and 0-10% acrylic acid. In some embodiments, the first filler material 118 and/or the second filler material 134 comprises a mixture of 27% methyl acrylate, 70% octadecyl acrylate, and 3% acrylic acid. (The preceding percentages are volume percentages.) In some embodiments, the first filler material 118 and/or the second filler material 134 comprises mixtures of esters, waxes, and/or acrylates. In some embodiments, the first filler material 118 and/or the second filler material 134 comprises a conductive filler such as graphene, which may be combined with an ester, wax, and/or acrylate. In some embodiments, the first filler material 118 and/or the second filler material 134 comprises an antioxidant, such as 2′,3-bis[[3-[3,5-di-tert-butyl-4-hydroxyphenyl]propionyl]]propionohydrazide (which goes by the trade name Ciba® IRGANOX® MD 1024) or Pentaerythritol Tetrakis(3-(3,5-di-tert-butyl-4-hydroxyphenyl)propionate) (which goes by the trade name Ciba® IRGANOX® 1010). In some embodiments, between 0.5-5% antioxidant improves the long term stability of the first filler material 118 and/or the second filler material 134.

In some embodiments, as described above, both the first layer 112 of carbon nanotubes and the second layer 130 of carbon nanotubes can withstand a shearing force of at least 0.5 Kgf without detaching from the copper substrate. In some embodiments, both the first layer 112 of carbon nanotubes and the second layer 130 of carbon nanotubes can withstand a shearing force of at least 3.3 Kgf without detaching from the copper substrate. In some embodiments, both the first layer 112 of carbon nanotubes and the second layer 130 of carbon nanotubes can withstand a shearing force of at least 5 Kgf without detaching from the copper substrate.

In some embodiments, as described above, both the first layer 112 of carbon nanotubes and the second layer 130 of carbon nanotubes can withstand an interfacial shearing stress of at least 30 psi without detaching from the copper substrate. In some embodiments, both the first layer 112 of carbon nanotubes and the second layer 130 of carbon nanotubes can withstand an interfacial shearing stress of at least 200 psi without detaching from the copper substrate. In some embodiments, both the first layer 112 of carbon nanotubes and the second layer 130 of carbon nanotubes can withstand an interfacial shearing stress of at least 300 psi without detaching from the copper substrate.

In some embodiments, as described above with respect to FIG. 6, the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface changes (e.g., increases) by less than a predetermined value (e.g., 5%, 10%, or 15%) after the copper substrate 102 with thermal interface materials 120 & 136 on the front and back surfaces, respectively, is subjected to one or more harsh environments (e.g., thermal cycling 604, HAST 606, high temperature storage 608, preconditioning 610, shock 612, and/or vibration 614).

In some embodiments, an integrated circuit or other solid-state device may be removably connected to the first thermal interface material 120. In some embodiments, the first thermal interface material 120 is configured to enable an integrated circuit or other solid-state device to be connected to the first thermal interface material, disconnected from the first thermal interface material, and then reconnected to the first thermal interface material. In some embodiments, the article of manufacture 900 is configured to be reused to cool a succession of integrated circuits or other solid-state devices.

In some embodiments, a Ranan spectrum of the first layer 112 containing carbon nanotubes has a D peak at ˜1350 cm⁻¹ with an intensity I_{D}, a G peak at ˜1585 cm⁻¹ with an intensity I_{G}, and an intensity ratio I_{D}/I_{G} of less than 0.7 at a laser excitation wavelength of 514 nm. In some embodiments, the intensity ratio I_{D}/I_{G} is less than 0.6.

In some embodiments, a Raman spectrum of the second layer 130 containing carbon nanotubes has a D peak at ˜1350 cm⁻¹ with an intensity I_{D}, a G peak at ˜1585 cm⁻¹ with an intensity I_{G}, and an intensity ratio I_{D}/I_{G} of less than 0.7 at a laser excitation wavelength of 514 nm. In some embodiments, the intensity ratio I_{D}/I_{G} is less than 0.6.

In some embodiments, the article of manufacture 1200 is a computer, such as a server computer, client computer, desktop computer, laptop computer, handheld computer, personal digital assistant, cell phone, gaming console, or handheld gaming device.

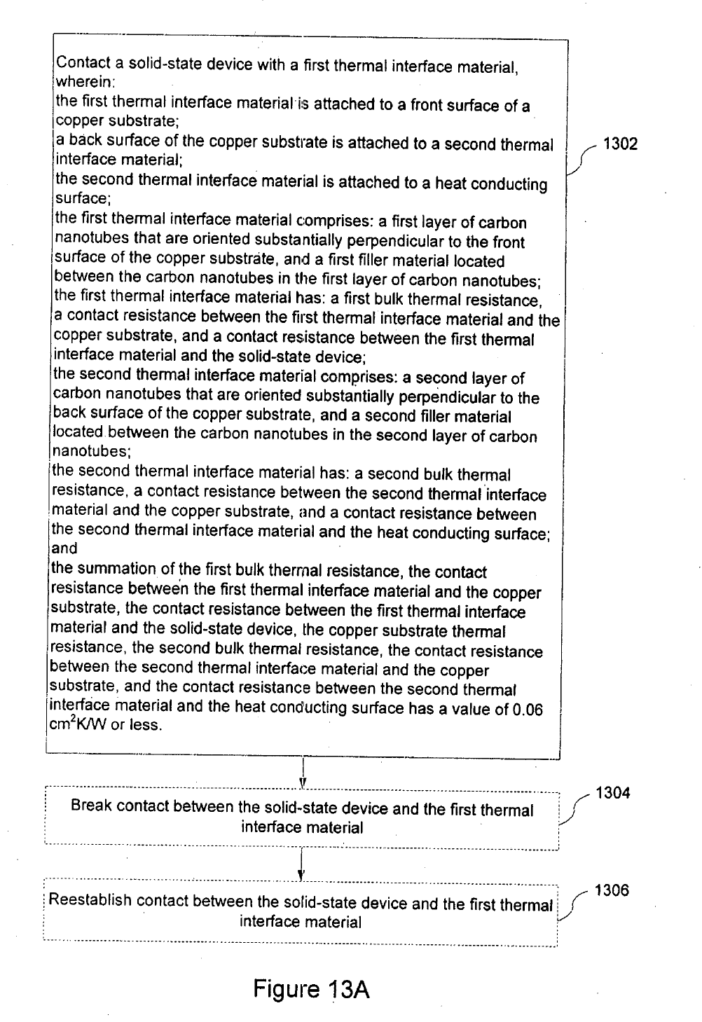

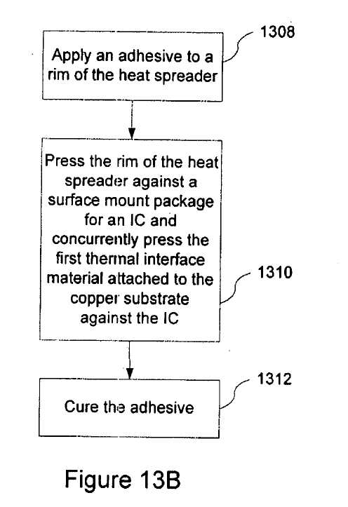

FIG. 13A is a flow diagram illustrating a process for contacting (1302) a solid-state device (e.g., integrated circuit 1210) with a first thermal interface material 120 in accordance with some embodiments. The first thermal interface material 120 is attached to a front surface 114 of a copper substrate 102. A back surface 115 of the copper substrate is attached to a second thermal interface material 136. The second thermal interface material 136 is attached to a heat conducting surface (e.g., heat spreader surface 906 or heat sink surface 1406).

The first thermal interface material 120 comprises: a first layer 112 of carbon nanotubes 116 that are oriented substantially perpendicular to the front surface 114 of the copper substrate, and a first filler material 118 located between the carbon nanotubes 116 in the first layer 112 of carbon nanotubes. The first thermal interface material 120 has: a first bulk thermal resistance, a contact resistance between the first thermal interface material and the copper substrate, and a contact resistance between the first thermal interface material and the solid-state device.

The second thermal interface material 136 comprises: a second layer 130 of carbon nanotubes that are oriented substantially perpendicular to the back surface 115 of the copper substrate, and a second filler material 134 located between the carbon nanotubes 132 in the second layer 130 of carbon nanotubes. The second thermal interface material 136 has: a second bulk thermal resistance, a contact resistance between the second thermal interface material and the copper substrate, and a contact resistance between the second thermal interface material and the heat conducting surface.

The summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.06 cm²K/W or less. In some embodiments, the summation is 0.05 cm²K/W or less. In some embodiments, the summation is 0.04 cm²K/W or less. In some embodiments, the summation is between 0.035-0.06 cm²K/W. These values are better than what is achieved with conventional thermal interface materials and with prior copper substrates with carbon nanotube-based thermal interface materials on both the front and back surfaces.

In some embodiments, a Raman spectrum of the first layer 112 containing carbon nanotubes has a D peak at ˜1350 cm⁻¹ with an intensity I_{D}, a G peak at ˜1585 cm⁻¹ with an intensity I_{G}, and an intensity ratio I_{D}/I_{G} of less than 0.7 at a laser excitation wavelength of 514 nm. In some embodiments, the intensity ratio I_{D}/I_{G} is less than 0.6.

In some embodiments, a Raman spectrum of the second layer 130 containing carbon nanotubes has a D peak at ˜1350 cm⁻¹ with an intensity I_{D}, a G peak at ˜1585 cm⁻¹ with an intensity I_{G}, and an intensity ratio I_{D}/I_{G} of less than 0.7 at a laser excitation wavelength of 514 nm. In some embodiments, the intensity ratio I_{D}/I_{G} is less than 0.6.

The heat spreader 902 and first thermal interface material 120 may be reworkable, which increases yields and reduces manufacturing costs. In some embodiments, contact between the solid-state device and the first thermal interface material 120 is broken (1304), and then contact between the solid-state device and the first thermal interface material is reestablished (1306).

FIG. 13B is a flow diagram illustrating a process for contacting an integrated circuit 1210 with a first thermal interface material 120 in accordance with some embodiments. In some embodiments, the contacting comprises: applying (1308) an adhesive to a rim (e.g., 220 or 920) of the heat spreader; pressing (1310) the rim of the heat spreader against a surface mount package for an integrated circuit (e.g., a ball grid array (BGA) package) and concurrently pressing the first thermal interface material 120 attached to the copper substrate 102 against the integrated circuit; and curing (1312) the adhesive.

In some embodiments, the first layer 112 of carbon nanotubes in the first thermal interface material 120 is designed to have sufficient compressibility so that the nanotubes contact the entire integrated circuit surface even if there are deviations in the flatness of the integrated circuit surface. For example, if the flatness of the integrated circuit surface being contacted varies by ±10 μm, the first layer of carbon nanotubes can be made with an average length of 30-50 μm, an average diameter of 100-150 nm, and a Young's Modulus of 30-150 GPa so that the overall thermal resistance of the copper substrate 102 and the two thermal interface materials 120 and 136 is low (e.g., 0.06 cm²K/W or less) when a pressure of 30-100 psi is applied to the heat spreader.

The copper substrate 102 with thermal interface materials on both the front and back surfaces disclosed herein may be used in a wide range of heat removal structures and methods. Structures and methods that use the copper substrate 102 with thermal interface materials on both the front and back surfaces in combination with a heat spreader are discussed above. FIG. 14A-14C illustrate side views of other articles of manufacture that include a copper substrate 102 with thermal interface materials on both the front and back surfaces in accordance with some embodiments.

In article 1200, described above, the copper substrate 102 with thermal interface materials 120 & 136 on the front and back surfaces, respectively, is used to conduct heat from a solid-state device (e.g., IC 1210) to a heat spreader 902.

Similarly, in article 1400, the copper substrate 102 with thermal interface materials 120 & 136 on the front and back surfaces, respectively, is used to conduct heat from a solid-state device (e.g., IC 1210) to a heat sink 1402.

Similarly, in article 1450 (FIG. 14B), the copper substrate 102 with thermal interface materials 120 & 136 on the front and back surfaces, respectively, is used to conduct heat from a heat spreader 902 to a heat sink 1402. Another copper substrate with thermal interface materials on the front and back surfaces of the copper substrate may contact the heat spreader (front) surface 906 and an integrated circuit 1210 (e.g., as shown in FIG. 12).

Similarly, in article 1470, the copper substrate 102 with thermal interface materials 120 & 136 on the front and back surfaces, respectively, is used to conduct heat in a stack of solid state devices (e.g., IC 1210-1 to 1210-4).

The summation of the copper substrate thermal resistance, the two bulk thermal resistances of the thermal interface materials 120 & 136, and the four contact resistances associated with the two thermal interface materials 120 & 136 is expected to be the same for articles 1400, 1450, 1470, and other articles incorporating the copper substrate 102 with thermal interface materials 120 & 136 on the front and back surfaces as it is for article 1200 (e.g., 0.06 cm²K/W or less, as discussed above). However, in article 1450, the contact resistance between the first thermal interface material 120 and a solid-state device is replaced by the contact resistance between the first thermal interface material 120 and another heat conducting surface (e.g., heat spreader back surface 910). Similarly, in article 1470, the contact resistance between the second thermal interface material 136 and a heat conducting surface is replaced by the contact resistance between the second-thermal interface material 136 and a second solid-state device (e.g., IC 1210-2).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. An article of manufacture, comprising:
a copper substrate with a front surface, a back surface, and a copper substrate thermal resistance;
a first adhesion layer that contacts the front surface of the copper substrate, wherein the first adhesion layer has a thickness between 200 and 5000 Å and comprises Ti, TiN, Cr, or Ta;
a first diffusion barrier layer that contacts the first adhesion layer, wherein the first diffusion barrier layer has a thickness between 100 and 400 Å and comprises TiN, SiO₂, Al₂O₃, or TaN;
a first catalyst on top of the first diffusion barrier layer, wherein the first catalyst has a thickness between 30 and 1000 Å and comprises Ni, Fe, or Co;
a first thermal interface material on top of the front surface of the copper substrate;
wherein the first thermal interface material comprises:
a first layer of carbon nanotubes that contacts the first catalyst, and
a first filler material located between carbon nanotubes in the first layer of carbon nanotubes;
wherein the carbon nanotubes in the first layer of carbon nanotubes are oriented substantially perpendicular to the front surface of the copper substrate;
wherein the first thermal interface material has:
a first bulk thermal resistance,
a contact resistance between the first thermal interface material and the copper substrate, and
a contact resistance between the first thermal interface material and a solid-state device;
a third adhesion layer that contacts the back surface of the copper substrate, wherein the third adhesion layer has a thickness between 200 and 5000 Å and comprises Ti, TiN, Cr, or Ta;
a second diffusion barrier layer that contacts the second adhesion layer, wherein the second diffusion barrier layer has a thickness between 100 and 600 Å and comprises TiN, SiO₂, Al₂O₃, or TaN;
a second catalyst on top of the second diffusion barrier layer, wherein the second catalyst has a thickness between 30 and 1000 Å and comprises Ni, Fe, or Co;
a second thermal interface material on top of the back surface of the copper substrate;
wherein the second thermal interface material comprises:
a second layer of carbon nanotubes that contacts the second catalyst, and
a second filler material located between carbon nanotubes in the second layer of carbon nanotubes;
wherein the carbon nanotubes in the second layer of carbon nanotubes are oriented substantially perpendicular to the back surface of the copper substrate;
wherein the second thermal interface material has:
a second bulk thermal resistance,
a contact resistance between the second thermal interface material and the copper substrate, and
a contact resistance between the second thermal interface material and a heat conducting surface;
wherein the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.06 cm²K/W or less.

2. An article of manufacture, comprising:
a copper substrate with a front surface, a back surface, and a copper substrate thermal resistance;
a first catalyst on top of the front surface of the copper substrate; and
a first thermal interface material on top of the front surface of the copper substrate;
wherein the first thermal interface material comprises:
a first layer of carbon nanotubes that contacts the first catalyst, and
a first filler material located between the carbon nanotubes in the first layer of carbon nanotubes;
wherein the carbon nanotubes in the first layer of carbon nanotubes are oriented substantially perpendicular to the front surface of the copper substrate;
wherein the first thermal interface material has:
a first bulk thermal resistance,
a contact resistance between the first thermal interface material and the copper substrate, and
a contact resistance between the first thermal interface material and a solid-state device;
a second catalyst on top of the back surface of the copper substrate; and
a second thermal interface material on top of the back surface of the copper substrate;
wherein the second thermal interface material comprises:
a second layer of carbon nanotubes that contacts the second catalyst, and
a second filler material located between the carbon nanotubes in the second layer of carbon nanotubes;
wherein the carbon nanotubes in the second layer of carbon nanotubes are oriented substantially perpendicular to the back surface of the copper substrate;
wherein the second thermal interface material has:
a second bulk thermal resistance,
a contact resistance between the second thermal interface material and the copper substrate, and
a contact resistance between the second thermal interface material and a heat conducting surface;
wherein the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat, conducting surface has a value of 0.06 cm²K/W or less.

3. The article of manufacture of claim 2, wherein the copper substrate has a thickness between 5 and 100 microns.

4. The article of manufacture of claim 2, wherein the copper substrate has a thickness between 5 and 25 microns.

5. The article of manufacture of claim 2, wherein the first filler material and/or the second filler material comprises a phase change material.

6. The article of manufacture of claim 2, wherein the first filler material and/or the second filler material comprises an ester, a wax, or an acrylate.

7. The article of manufacture of claim 6, wherein the first filler material and/or the second filler material comprises graphene.

8. The article of manufacture of claim 6, wherein the first filler material and/or the second filler material comprises an antioxidant.

9. The article of manufacture of claim 2, wherein the first filler material and/or the second filler material has a viscosity between 0.5-100 cSt at 25° C., a melting point between 40-80° C., a modulus between 50-1000 psi, and a surface tension between 1-100 dyne/cm.

10. The article of manufacture of claim 2, wherein the first filler material and/or the second filler material has a viscosity between 0.5-10 cSt at 25° C., a melting point between 50-60° C., a modulus between 50-150 psi, a surface tension between 1-20 dyne/cm, and a boiling point of at least 250° C.

11. The article of manufacture of claim 2, wherein the first filler material and/or the second filler material comprises a mixture of esters, waxes, and/or acrylates.

12. The article of manufacture of claim 2, wherein the first filler material and/or the second filler material comprises a mixture of acrylates.

13. The article of manufacture of claim 2, wherein the first filler material and/or the second filler material comprises a mixture of methyl acrylate, octadecyl acrylate, and acrylic acid.

14. The article of manufacture of claim 2, wherein the first filler material and/or the second filler material comprises a mixture of 0-50% methyl acrylate, 50-90% octadecyl acrylate, and 0-10% acrylic acid.

15. The article of manufacture of claim 2, wherein the first filler material and/or the second filler material comprises a mixture of 27% methyl acrylate, 70% octadecyl acrylate, and 3% acrylic acid.

16. The article of manufacture of claim 2, wherein the both the first layer of carbon nanotubes and the second layer of carbon nanotubes are attached to the copper substrate and can withstand a shearing force of at least 0.5 Kgf without detaching from the copper substrate.

17. The article of manufacture of claim 2, wherein the both the first layer of carbon nanotubes and the second layer of carbon nanotubes are attached to the copper substrate and can withstand a shearing force of at least 3.3 Kgf without detaching from the copper substrate.

18. The article of manufacture of claim 2, wherein the both the first layer of carbon nanotubes and the second layer of carbon nanotubes are attached to the copper substrate and can withstand a shearing force of at least 5 Kgf without detaching from the copper substrate.

19. The article of manufacture of claim 2, wherein both the first layer of carbon nanotubes and the second layer of carbon nanotubes are attached to the copper substrate and can withstand an interfacial shearing stress of at least 30 psi without detaching from the copper substrate.

20. The article of manufacture of claim 2, wherein both the first layer of carbon nanotubes and the second layer of carbon nanotubes are attached to the copper substrate and can withstand an interfacial shearing stress of at least 200 psi without detaching from the copper substrate.

21. The article of manufacture of claim 2, wherein both the first layer of carbon nanotubes and the second layer of carbon nanotubes are attached to the copper substrate and can withstand an interfacial shearing stress of at least 300 psi without detaching from the copper substrate.

22. The article of manufacture of claim 2, wherein the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface changes by less than 10% when the article of manufacture is cycled from −40° C. to 125° C. with a 25° C./min ramp and 5 minute dwell times for 1000 cycles.

23. The article of manufacture of claim 2, wherein the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface changes by less than 10% when the article of manufacture is heated at 120° C. for 96 hours in 85% relative humidity.

24. The article of manufacture of claim 2, wherein the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface changes by less than 10% when the article of manufacture is heated at 150° C. for 1000 hours.

25. The article of manufacture of claim 2, wherein the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface changes by less than 10% when the article of manufacture is: cycled from −40° C. to 125° C. with a 10° C./min ramp and 10 minute dwell times for 5 cycles, then heated at 125° C. for 24 hours, then heated at 30° C. for 192 hours in 60% relative humidity, and then cycled from 25° C. to 260° C. for 3 cycles.

26. The article of manufacture of claim 2, wherein the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface changes by less than 10% when the article of manufacture is subjected to a variable frequency vibration comprising 4 4-minute cycles from 20 Hz to 2000 Hz and back to 20 Hz performed in each of three orthogonal orientations with a peak acceleration of 20 G.

27. The article of manufacture of claim 2, wherein the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface changes by less than 10% when the article of manufacture is subjected to Gaussian random vibration with 1.11 G root mean square (RMS) acceleration, 1.64 in/sec RMS velocity, 0.0310 inches RMS displacement, and 0.186 three sigma peak-to-peak displacement for 30 minutes in each of three orthogonal axes.

28. The article of manufacture of claim 2, wherein the value of the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface changes by less than 10% when the article of manufacture is subjected to a mechanical shock of 1500 G in a 0.5 ms, half sine wave pulse, with 5 such shocks applied along 6 different axes.

29. The article of manufacture of claim 2, wherein the copper substrate contains less than 40 ppm oxygen.

30. The article of manufacture of claim 2, wherein the copper substrate contains 10 ppm oxygen or less.

31. The article of manufacture of claim 2, wherein the copper substrate is oxygen-free copper.

32. The article of manufacture of claim 2, wherein the copper substrate has a cross-sectional area that substantially corresponds to the cross-sectional area of the solid-state device.

33. The article of manufacture of claim 32, wherein the solid-state device is a light emitting diode, laser, power transistor, RF device, or solar cell.

34. The article of manufacture of claim 2, wherein the copper substrate has a cross-sectional area that substantially corresponds to the cross-sectional area of an integrated circuit.

35. The article of manufacture of claim 2, including a first adhesion layer that contacts the front surface of the copper substrate.

36. The article of manufacture of claim 35, wherein the first adhesion layer has a thickness between 200 and 5000 Å and comprises Ti, TiN, Cr, or Ta.

37. The article of manufacture of claim 35, wherein the first adhesion layer has a thickness between 200 and 500 Å and comprises Ti.

38. The article of manufacture of claim 35, including a first diffusion barrier layer on top of the first adhesion layer.

39. The article of manufacture of claim 38, wherein the first diffusion barrier layer has a thickness between 100 and 400 Å and comprises TiN, SiO₂, Al₂O₃, or TaN.

40. The article of manufacture of claim 38, wherein the first diffusion barrier layer has a thickness between 100 and 400 Å and comprises TiN.

41. The article of manufacture of claim 38, including a second adhesion layer between the first diffusion barrier layer and the first catalyst.

42. The article of manufacture of claim 41, wherein the second adhesion layer has a thickness between 25 and 400 Å and comprises Ti, SiO₂, TN, Al₂O₃, or Mo.

43. The article of manufacture of claim 41, wherein the second adhesion layer has a thickness between 25 and 200 Å and comprises Ti.

44. The article of manufacture of claim 2, wherein the first catalyst has a thickness between 30 and 1000 Å and comprises Ni, Fe, or Co.

45. The article of manufacture of claim 2, wherein the first catalyst has a thickness between 200 and 400 Å and comprises Ni.

46. The article of manufacture of claim 2, including a third adhesion layer that contacts the back surface of the copper substrate.

47. The article of manufacture of claim 46, wherein the third adhesion layer has a thickness between 200 and 5000 Å and comprises Ti, TiN, Cr, or Ta.

48. The article of manufacture of claim 46, wherein the third adhesion layer has a thickness between 200 and 600 Å and comprises Cr.

49. The article of manufacture of claim 46, including a second diffusion barrier layer on top of the third adhesion layer.

50. The article of manufacture of claim 49, wherein the second diffusion barrier layer has a thickness between 100 and 600 Å and comprises TiN, SiO₂, Al₂O₃, or TaN.

51. The article of manufacture of claim 49, wherein the second diffusion barrier layer has a thickness between 400 and 600 Å and comprises SiO₂ or Al₂O₃.

52. The article of manufacture of claim 49, including a fourth adhesion layer between the second diffusion barrier layer and the second catalyst.

53. The article of manufacture of claim 52, wherein the fourth adhesion layer has a thickness between 25 and 400 Å and comprises Ti, SiO₂, TiN, Al₂O₃, or Mo.

54. The article of manufacture of claim 52, wherein the fourth adhesion layer has a thickness between 25 and 200 Å and comprises Ti.

55. The article of manufacture of claim 2, wherein the second catalyst has a thickness between 30 and 1000 Å and comprises Ni, Fe, or Co.

56. The article of manufacture of claim 2, wherein the second catalyst has a thickness between 30 and 100 Å and comprises Fe.

57. The article of manufacture of claim 2, wherein the carbon nanotubes in the first layer of carbon nanotubes and/or the carbon nanotubes in the second layer of carbon nanotubes have an average diameter between 60 nm and 200 nm.

58. The article of manufacture of claim 57, wherein the carbon nanotubes in the first layer of carbon nanotubes and/or the carbon nanotubes in the second layer of carbon nanotubes have a tip density between 10 and 40 nanotubes per μm².

59. The article of manufacture of claim 2, wherein the carbon nanotubes in the first layer of carbon nanotubes and/or the carbon nanotubes in the second layer of carbon nanotubes have an average diameter between 100 nm and 150 nm.

60. The article of manufacture of claim 2, wherein the carbon nanotubes in the first layer of carbon nanotubes and/or the carbon nanotubes in the second layer of carbon nanotubes have a surface area coverage density between 15 and 40 percent.

61. The article of manufacture of claim 2, wherein the carbon nanotubes in the first layer of carbon nanotubes and the carbon nanotubes in the second layer of carbon nanotubes comprise multiwalled carbon nanotubes.

62. The article of manufacture of claim 2, wherein substantially all of the carbon nanotubes in the first layer of carbon nanotubes are individually separated from each other and substantially all of the carbon nanotubes in the second layer of carbon nanotubes are individually separated from each other.

63. The article of manufacture of claim 2, wherein the carbon nanotubes in the first layer of carbon nanotubes and/or the carbon nanotubes in the second layer of carbon nanotubes have an average length between 5 and 50 μm.

64. The article of manufacture of claim 2, wherein the carbon nanotubes in the first layer of carbon nanotubes and/or the carbon nanotubes in the second layer of carbon nanotubes have an average length between 20 and 45 μm.

65. The article of manufacture of claim 2, wherein a Raman spectrum of the first layer of carbon nanotubes and/or a Raman spectrum of the second layer of carbon nanotubes has a D peak at ˜1350 cm⁻¹ with an intensity I_{D}, a G peak at ˜1585 cm⁻¹ with an intensity I_{G}, and an intensity ratio I_{D}/I_{G} of less than 0.7 at a laser excitation wavelength of 514 nm.

66. The article of manufacture of claim 2, wherein the Raman spectrum of the first layer of carbon nanotubes and/or a Raman spectrum of the second layer of carbon nanotubes has a D peak at ˜1350 cm⁻¹ with an intensity I_{D} a G peak at ˜1585 cm⁻¹ with an intensity I_{G}, and an intensity ratio I_{D}/I_{G} of less than 0.6 at a laser excitation wavelength of 514 nm.

67. The article of manufacture of claim 2, wherein the solid-state device is an integrated circuit.

68. The article of manufacture of claim 2,
wherein the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.04 cm²K/W or less.

69. The article of manufacture of claim 68, wherein the solid-state device is an integrated circuit.

70. The article of manufacture of claim 2,
wherein the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value between 0.035-0.06 cm²K/W.

71. The article of manufacture of claim 70, wherein the solid-state device is an integrated circuit.

72. The article of manufacture of claim 2, wherein the solid-state device may be removably connected to the first thermal interface material.

73. The article of manufacture of claim 72, wherein the solid-state device is an integrated circuit.

74. The article of manufacture of claim 2, wherein the first thermal interface material is configured to enable a solid-state device to be connected to the first thermal interface material, disconnected from the first thermal interface material, and then reconnected to the first thermal interface material.

75. The article of manufacture of claim 74, wherein the solid-state device is an integrated circuit.

76. The article of manufacture of claim 2, wherein the article of manufacture is configured to be reused to cool a succession of solid-state devices.

77. The article of manufacture of claim 76, wherein the solid-state devices are integrated circuits.

78. An article of manufacture, comprising:
a heat spreader;
a copper substrate with a front surface, a back surface, and a copper substrate thermal resistance;
a first thermal interface material attached to the front surface of the copper substrate comprising a first layer of carbon nanotubes and a first filler material located between carbon nanotubes in the first layer of carbon nanotubes;
wherein the carbon nanotubes in the first layer of carbon nanotubes are oriented substantially perpendicular to the front surface of the copper substrate;
wherein the first thermal interface material has:
a first bulk thermal resistance,
a contact resistance between the first thermal interface material and the front surface of the copper substrate, and
a contact resistance between the first thermal interface material and a solid-state device;
a second thermal interface material attached to the back surface of the copper substrate comprising a second layer of carbon nanotubes and a second filler material located between carbon nanotubes in the second layer of carbon nanotubes;
wherein the carbon nanotubes in the second layer of carbon nanotubes are oriented substantially perpendicular to the back surface of the copper substrate;
wherein the second thermal interface material has:
a second bulk thermal resistance,
a contact resistance between the second thermal interface material and the back surface of the copper substrate, and
a contact resistance between the second thermal interface material and a heat conducting surface of the heat spreader;
wherein the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.06 cm²K/W or less.

79. An article of manufacture, comprising:
a copper substrate with a front surface, a back surface, and a copper substrate thermal resistance;
a first catalyst on top of the front surface of the copper substrate; and
a first thermal interface material on top of the front surface of the copper substrate;
wherein the first thermal interface material comprises:
a first layer of carbon nanotubes that contacts the first catalyst, and
a first filler material located between the carbon nanotubes in the first layer of carbon nanotubes;
wherein the carbon nanotubes in the first layer of carbon nanotubes are oriented substantially perpendicular to the front surface of the copper substrate;
wherein the first thermal interface material has:
a first bulk thermal resistance,
a contact resistance between the first thermal interface material and the copper substrate, and
a contact resistance between the first thermal interface material and a first heat conducting surface;
a second catalyst on top of the back surface of the copper substrate; and
a second thermal interface material on top of the back surface of the copper substrate;
wherein the second thermal interface material comprises:
a second layer of carbon nanotubes that contacts the second catalyst, and
a second filler material located between the carbon nanotubes in the second layer of carbon nanotubes;
wherein the carbon nanotubes in the second layer of carbon nanotubes are oriented substantially perpendicular to the back surface of the copper substrate;
wherein the second thermal interface material has:
a second bulk thermal resistance,
a contact resistance between the second thermal interface material and the copper substrate, and
a contact resistance between the second thermal interface material and a second heat conducting surface;
wherein the summation of the first bulk thermal resistance, the contact resistance between the first thermal interface material and the copper substrate, the contact resistance between the first thermal interface material and the first heat conducting surface, the copper substrate thermal resistance, the second bulk thermal resistance, the contact resistance between the second thermal interface material and the copper substrate, and the contact resistance between the second thermal interface material and the second heat conducting surface has a value of 0.06 cm²K/W or less.

80. An article of manufacture, comprising:
a heat sink;
a copper substrate with a front surface, a back surface, and a copper substrate thermal resistance;
a first thermal interface material attached to the front surface of the copper substrate comprising a first layer of carbon nanotubes and a first filler material located between carbon nanotubes in the first layer of carbon nanotubes;
wherein the carbon nanotubes in the first layer of carbon nanotubes are oriented substantially perpendicular to the front surface of the copper substrate;
wherein the first thermal interface material has:
a first bulk thermal resistance,
a contact resistance between the first thermal interface material and the front surface of the copper substrate, and
a contact resistance between the first thermal interface material and a solid-state device;
a second thermal interface material attached to the back surface of the copper substrate comprising a second layer of carbon nanotubes and a second filler material located between carbon nanotubes in the second layer of carbon nanotubes;
wherein the carbon nanotubes in the second layer of carbon nanotubes are oriented substantially perpendicular to the back surface of the copper substrate;
wherein the second thermal interface material has:
a second bulk thermal resistance,
a contact resistance between the second thermal interface material and the back surface of the copper substrate, and
a contact resistance between the second thermal interface material and a heat conducting surface of the heat sink;
wherein the summation of the first bulk thermal resistance, the contact resistance between the first thermal interface material and the copper substrate, the contact resistance between the first thermal interface material and the solid-state device, the copper substrate thermal resistance, the second bulk thermal resistance, the contact resistance between the second thermal interface material and the copper substrate, and the contact resistance between the second thermal interface material and the heat conducting surface has a value of 0.06 cm²K/W or less.

81. An article of manufacture, comprising:
a copper substrate with a front surface, a back surface, and a copper substrate thermal resistance;
a first catalyst on top of the front surface of the copper substrate; and
a first thermal interface material on top of the front surface of the copper substrate;
wherein the first thermal interface material comprises:
a first layer of carbon nanotubes that contacts the first catalyst, and
a first filler material located between the carbon nanotubes in the first layer of carbon nanotubes;
wherein the carbon nanotubes in the first layer of carbon nanotubes are oriented substantially perpendicular to the front surface of the copper substrate;
wherein the first thermal interface material has:
a first bulk thermal resistance,
a contact resistance between the first thermal interface material and the copper substrate, and
a contact resistance between the first thermal interface material and a first solid-state device;
a second catalyst on top of the back surface of the copper substrate; and
a second thermal interface material on top of the back surface of the copper substrate;
wherein the second thermal interface material comprises:
a second layer of carbon nanotubes that contacts the second catalyst, and
a second filler material located between the carbon nanotubes in the second layer of carbon nanotubes;
wherein the carbon nanotubes in the second layer of carbon nanotubes are oriented substantially perpendicular to the back surface of the copper substrate;
wherein the second thermal interface material has:
a second bulk thermal resistance,
a contact resistance between the second thermal interface material and the copper substrate, and
a contact resistance between the second thermal interface material and a second solid-state device;
wherein the summation of the first bulk thermal resistance, the contact resistance between the first thermal interface material and the copper substrate, the contact resistance between the first thermal interface material and the first solid-state device, the copper substrate thermal resistance, the second bulk thermal resistance, the contact resistance between the second thermal interface material and the copper substrate, and the contact resistance between the second thermal interface material and the second solid-state device has a value of 0.06 cm²K/W or less.
